(19) United States
(12) Patent Application Publication
(10) Pub. No.: US 2005/0256956 A1
(43) Pub. Date: Nov. 17, 2005

(54) Analyzing user-activity data using a heuristic-based approach

(75) Inventors: Richard J. Littlefield, Richland, WA (US); Janis S. Littlefield, Richland, WA (US); Barbara J. Cheney, Richland, WA (US); Paula J. Cowley, Richland, WA (US); Daniel R. Adams, Chantilly, VA (US); Alex G. Gibson, West Richland, WA (US); Jereme N. Haack, West Richland, WA (US); Laura M. Curtis, West Richland, WA (US); Jonathon D. McCall, West Richland, WA (US)

Correspondence Address: KLARQUIST SPARKMAN, LLP, 121 SW SALMON STREET, SUITE 1600, ONE WORLD TRADE CENTER, PORTLAND, OR, 97204, US

(73) Assignee: Battelle Memorial Institute

(21) Appl. No.: 10/965,473

(22) Filed: Oct. 13, 2004

Related U.S. Application Data
(60) Provisional application No. 60/571,001, filed on May 14, 2004.

(51) Int. Cl. H04L 9/00

(52) U.S. Cl. 709/225

(57) ABSTRACT

Methods, apparatus, and systems for analyzing user-activity data are disclosed. In one disclosed embodiment, for example, two or more data streams of low-level, user-activity data are detected at a computer workstation via two or more respective sensors. The two or more respective sensors may comprise a first sensor configured to detect network-access requests and a second sensor configured to detect at least one of the following events: file-activity events, window-title-change events, or user-interface events. Targeted user activity is identified from at least one of the data streams. The targeted user activity can comprise, for example, a user initiating a network access; performing a search on a search engine; creating, opening, or modifying a file; or initiating a network access that causes a window title to change. Computer-readable media containing computer-executable instructions for causing a computer system to perform any of the described methods or for storing lists created or modified by any of the disclosed methods are also disclosed.

### CROSS-REFERENCE TO RELATED APPLICATION

This application claims the benefit of U.S. Provisional Application No. 60/571,001, filed May 14, 2004, which is incorporated herein by reference.

### STATEMENT OF GOVERNMENT SUPPORT

This invention was made with Government support under a contract awarded by an agency of the United States Government. The Government has certain rights in the invention.

### FIELD

This application relates to data-analysis tools and techniques, which may be used, for example, to analyze a user's activities at their computer workstation.

### BACKGROUND

With the advent of distributed computer networks connecting multiple users to large databases of information, the personal computer has emerged as an important research and informational tool. The largest such network, commonly known as the Internet, has given computer users unprecedented access to a seemingly limitless amount of information (including government records, publication databases, and other information sources). In certain situations, however, it is desirable to monitor a user's activity concerning such networks as well as monitoring the user's other activities at their workstation. For example, it may be desirable for some business owners to monitor the activities of their employees as they work at their workstations (e.g., to better understand their employees' analytical processes or to account for computer and Internet activity). Simply recording what events occur at a user's workstation (i.e., recording the low-level, user activity such as keystrokes, mouse actions, file accesses, and network-access requests), however, can produce an enormous amount of user-activity data that does not offer much insight into what the user was actually intending to do. Accordingly, techniques and tools that help analyze low-level, user-activity data and extract targeted information indicative of what the user intended to do are desirable.

### SUMMARY

Disclosed below are representative embodiments of methods, apparatus, and systems for analyzing user-activity data. The disclosed methods, apparatus, and systems should not be construed as limiting in any way. Instead, the present disclosure is directed toward all novel and non-obvious features and aspects of the various disclosed embodiments and their equivalents, alone and in various combinations and sub-combinations with one another. Further, the disclosed methods, apparatus, and systems are not limited to any specific aspect, feature, or combination thereof, nor do the disclosed methods, apparatus, or systems require that any one or more specific advantages be present or problems be solved.

In one disclosed embodiment, user-activity data is received. The user-activity data of this embodiment comprises one or more network-access requests (e.g., uniform-resource-locator (URL) addresses accessed by the computer workstation). A selected network-access request from the user-activity data (e.g., a network-access request that is determined to be responsive to an immediately prior user-interface event, such as a keystroke or mouse event) is compared to one or more known non-user-initiated network-access requests. The selected network-access request is designated as being a user-initiated network-access request based at least in part on the comparison. A list of targeted user activities comprising at least the designated user-initiated network-access request can be output. In certain implementations, the act of comparing includes determining that the selected network-access request does not match any of the known non-user-initiated network-access requests. In some implementations, the known non-user-initiated network-access requests are stored in one or more lists of known non-user-initiated network-access requests. These lists might comprise, for example, URL addresses known to be secondary URL addresses or URL addresses known to be of a non-primary type. The selected network-access request may be a first network-access request, and the method may further comprise identifying a second selected network-access request as being a non-user-initiated network-access request from the user-activity data. One of the lists of non-user-initiated network-access requests may then be updated to include the non-user-initiated network-access request identified. In such implementations, the method may further comprise determining that the second selected network-access request does not immediately follow a user-interface event.

In another disclosed embodiment, data indicating activity at a computer workstation is received. In this embodiment, the data comprises entries indicative of network-access requests from the computer workstation (e.g., URL addresses). The network-access requests comprise both user-initiated network-access requests and non-user-initiated network-access requests. One or more of the network-access requests are designated as user-initiated network-access requests via the data indicating activity at the computer workstation. In certain implementation, the user-activity data additionally comprises entries indicative of user-interface events, and the method includes identifying at least on of the user-interface events as a user-interface event initiating at least one of the network-access requests. The act of designating one or more of the network-access requests as user-initiated network-access requests may, in some implementations, comprise searching one or more lists of non-user-initiated network-access requests. Additionally, one or more of the network-access requests may be identified as non-user-initiated network-access requests via the data. One or more search queries may also be identified from the network-access requests. The method can further comprise updating a list of non-user-initiated network-access requests with one or more of the network-access requests identified as non-user-initiated network-access requests.

In another disclosed embodiment, user-activity data is received. In this embodiment, the user-activity data comprises one or more network-access requests (e.g., URL addresses). A selected network-access request from the user-activity data is compared to known search-engine-query addresses. By matching the selected network-access request to one of the known search-engine-query addresses, the selected network-access request is identified as being a search-engine query. A user query to the search engine may also be identified from the selected network-access request. The method may further comprise outputting a list of targeted user activities, wherein the list of targeted user activities comprises at least the search-engine query identified. In certain implementations, the known search-engine-query addresses comprise URL addresses for known Internet search engines.

In another disclosed embodiment, user-activity data is received. In this embodiment, the user-activity data comprises one or more file-activity events, wherein each file-activity event is indicative of a respective file that was accessed by a computer workstation and a process that accessed the respective file on the computer workstation. Two or more of the file-activity events are clustered together. In this embodiment, the clustered file-activity events involve a common process accessing a common file within respective time intervals from one another. The clustered file-activity events are classified as being representative of a targeted file action. In certain implementations, the act of classifying comprises comparing a time associated with the clustered file-activity events to a creation time and a modification time of the common file, and designating the clustered file-activity events as representing a creation, a modification, or an opening of the common file based at least in part on the comparison. The acts of comparing and designating may be performed for the clustered file-activity events only after the clustering is determined to be complete. In some implementations, the method also comprises deleting a selected file-activity event from the user-activity data if the selected file-activity event indicates access to a file on a list of excluded files (e.g., a list comprising temporary files). A list of targeted user activities comprising at least the targeted file action represented by the clustered file-activity events can be output. In certain implementations, the acts of clustering and classifying are performed substantially as the user-activity data is received.

In another disclosed embodiment, network-access requests from a computer workstation and network responses to the network-access requests are monitored. A network response is identified that directs the computer workstation to perform a window title change (e.g., a network response comprising an HTML directive to change window titles). The identified network response is received in response to a corresponding network-access request (e.g., a network-access request comprising a URL address). A determination is made that a window on the computer workstation changed as a result of the identified network response, and the window is associated with the corresponding network-access request. In some implementations, the act of determining comprises evaluating whether the window on the computer workstation changed titles within a predetermined period of time of the identified network response and whether a new title of the window matches a title directed by the identified network response. The method may further comprise displaying the corresponding network-access request to a user when the associated window is active. In certain implementations, the acts of identifying, determining, and associating are performed substantially concurrent with the monitoring.

In another embodiment, a method for analyzing user-activity data is disclosed. In this embodiment, two or more data streams of low-level, user-activity data are detected at a computer workstation via two or more respective sensors. In this embodiment, the two or more respective sensors comprise at least a first sensor configured to detect network-access requests and a second sensor configured to detect at least one of the following: file-activity events, window-title-change events, or user-interface events. Targeted user activity is identified from at least one of the data streams. The targeted user activity is stored, whereas the remainder of the data stream from which it was identified is disregarded. In some implementations, the targeted user activity is identified using a combination of at least two of the data streams. The targeted user activity can comprise, for example, a user initiating a network access; performing a search on a search engine; creating, opening, or modifying a file; or initiating a network access that causes a window title to change. In certain implementations, the act of identifying the targeted user activity is performed substantially as a corresponding data stream is received. In some implementations, the targeted user activity is displayed via a graphical user interface and/or stored in a list of targeted user activity on one or more computer-readable media.

Any of the disclosed methods may be implemented as computer-readable media comprising computer-executable instructions for causing a computer to perform the method. Further, computer-readable media comprising lists at least partially created or modified by the disclosed methods are also provided. The disclosed embodiments may also be implemented (partially or completely) in hardware (e.g., one or more integrated circuits).

The foregoing and additional features and advantages of the disclosed embodiments will become more apparent from the following detailed description, which proceeds with reference to the following drawings.

### BRIEF DESCRIPTION OF THE DRAWINGS

FIG. 1 is a block diagram illustrating an exemplary computing environment in which a user's activities can be detected and recorded.

FIG. 2 shows an exemplary table comprising low-level, user-activity data (namely, network-access events and user-interface events) that can be detected using the computing environment of FIG. 1.

FIGS. 3A and 3B show a flow chart of a general method for using a heuristic-based approach to analyze user-activity data.

FIG. 4A shows an exemplary table comprising targeted user activity (namely, user-initiated Web-access requests) identified from the low-level, user-activity data from FIG. 2.

FIG. 4B shows an exemplary table comprising targeted user activities (namely, user queries to network search engines and user-initiated Web-access requests) identified from the user-activity data in FIG. 2.

FIG. 5 is a flow chart of a general method for identifying user-initiated, network-access requests from low-level, user-activity data.

FIG. 6 is a flow chart of a specific implementation of the general method shown in FIG. 5 adapted to identify primary URL addresses accessed by the user.

FIG. 7 is a flow chart of a general method for identifying user queries to a network search engine from low-level, user-activity data.

FIG. 8 is a flow chart of a specific implementation of the general method shown in FIG. 7 adapted to identify user queries to Internet search engines.

FIG. 9 is a flow chart of a general method for identifying targeted file activities from low-level, user-activity data.

FIGS. 10A and 10B show a flow chart of a specific implementation of the general method shown in FIG. 9 adapted to identify file activities and classify them as representing the creation, opening, or modification of a file.

FIG. 11 is an exemplary table comprising low-level, user-activity data (namely, file-activity data) that can be detected using the computing environment of FIG. 1.

FIG. 12 shows an exemplary table comprising targeted user activity (namely, targeted file activities) identified from the low-level, user-activity data from FIG. 11.

FIG. 13 is a flow chart of a general method for associating a network-access request with a window on a user's workstation.

FIG. 14 is a flow chart of a specific implementation of the general method shown in FIG. 13.

FIG. 15 is an exemplary table comprising low-level, user-activity data (namely, network-access requests and window-title-change events) that can be detected using the computing environment of FIG. 1.

FIG. 16 shows an exemplary window on a user's workstation wherein the network-access request that initiated the window is displayed.

FIG. 17 is a block diagram illustrating an exemplary distributed computing environment in which the activity of multiple users can be detected, recorded, and analyzed.

FIG. 18 is a block diagram showing an exemplary manner in which user-activity data can be analyzed in the distributed computing environment illustrated in FIG. 17.

### DETAILED DESCRIPTION

### General Considerations

Disclosed below are representative embodiments of methods, apparatus, and systems for analyzing user-activity data (e.g., a user's activity at a computer workstation). The disclosed methods may be used, for example, in software or hardware tools (or combinations thereof) that detect, record, analyze, and/or display user-activity data.

The disclosed methods, apparatus, and systems should not be construed as limiting in any way. Instead, the present disclosure is directed toward novel and non-obvious features and aspects of the various disclosed embodiments and their equivalents, alone and in various combinations and sub-combinations with one another. Moreover, the methods, apparatus, and systems are not limited to any specific aspect or feature, or combination thereof, nor do the disclosed methods, apparatus, and systems require that any one or more specific advantages be present or problems be solved.

Although the operations of some of the disclosed methods, apparatus, and systems are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine” and “identify” to describe the disclosed methods. These terms are high-level abstractions of the operations that are performed. The operations that correspond to these terms will vary depending on the particular implementation and are readily discernible by one of ordinary skill in the art.

The disclosed embodiments can be implemented in a wide variety of environments. For example, any of the disclosed techniques can be implemented in software comprising computer-executable instructions stored on a computer-readable medium. Such software can comprise, for example, monitoring or instrumenting software used to capture and record user activities on a multi-user and/or networked computer system. Such software can be executed on a single computer or on a networked computer (e.g., via the Internet, a wide-area network, a local-area network, a client-server network, or other such network). For clarity, only certain selected aspects of the software-based implementations are described. Other details that are well known in the art are omitted. For example, it should be understood that the disclosed technology is not limited to any specific computer language, program, or computer. For the same reason, computer hardware is not described in further detail. Any of the disclosed methods can alternatively be implemented (partially or completely) in hardware (e.g., on a system-on-a-chip (SoC), application-specific integrated circuit (ASIC), or programmable logic device (PLD), such as a field programmable gate array (FPGA)).

The disclosed technology is generally applicable to any field in which it is desirable to record and analyze a user's activities (e.g., commercial businesses monitoring their employees or Website, parents monitoring the computer and Internet activity of their children, non-commercial research, intelligence analysis, and other such fields).

### Exemplary Computing Environments for Detecting User-Activity Data

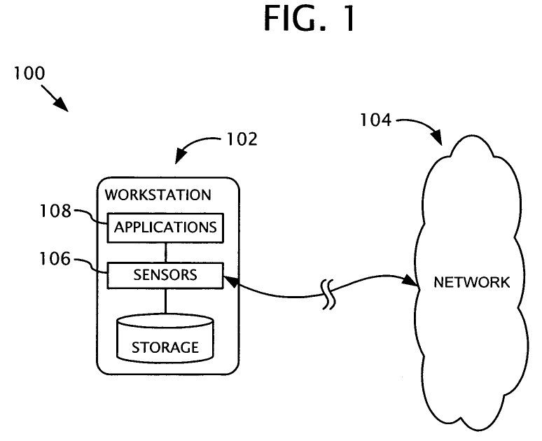

FIG. 1 illustrates an exemplary computing environment 100 that can be used in conjunction with the disclosed technology. In particular, a user's computer (or workstation) 102 is shown. The workstation 102 is configured to communicate with at least one network 104, the access of which is desirably monitored and analyzed. For example, in some embodiments, the workstation 102 is coupled to the Internet through an appropriate communication protocol (e.g., TCP/IP or HTTP). The disclosed technology, however, is not limited to analyzing user activity on the Internet and may be generally adapted to analyze user activity concerning other networks or databases (e.g., local or private networks and databases (such as the Lexis/Nexis databases or the USPTO databases)).

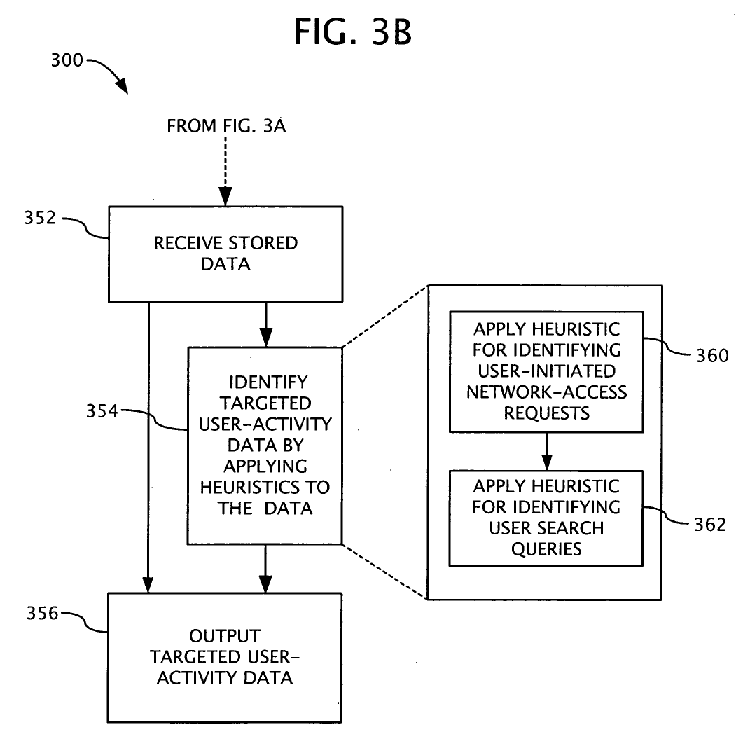

In order to gather as much information as possible about a user's work, it is desirable to capture and record the user's activities on their workstation 102. With reference to FIG. 1, the workstation 102 can utilize one or more sensors 106 to record a user's actions with respect to one or more software applications 108 used on the workstation. The sensors 106 may comprise software sensors, hardware sensors, or combinations thereof. For example, the one or more sensors 106 can comprise a proxy server adapted to receive, record, and pass on requests to access a network or classes of resources on a network (referred to herein as “network-access requests”) and the network responses thereto. In one embodiment, for instance, a proxy server (e.g., an HTTP-level proxy) operates in connection with a workstation's Web browser (e.g., the Internet Explorer® or Navigator® Web browser) to receive and forward network-access requests and Internet-server responses. In this embodiment, the network-access requests that are recorded can comprise all or part of the uniform-resource-locator (URL) addresses that are requested by the Web browser. For example, the network-access request that is recorded can comprise the protocol-type portion of the URL address (e.g., “http://”), the resource-location portion of the URL address (e.g., “www.google.com”), the parameter portion of the URL address (e.g., “?h1=en&ie=UTF-8&q=patent+office”), or any combination or sub-combination thereof. In one particular non-limiting implementation (which is illustrated in FIGS. 4A and 4B), the network-access requests comprise the complete URL address. Generally speaking, however, a network-access request comprises the information used to identify the location of objects (such as files or Web pages) within a network.

A proxy server is used in certain embodiments of the disclosed technology because most computer systems (for example, computers using the Microsoft® Windows® or Unix® operating systems) do not provide explicit “hooks” that monitoring software can use to detect and record network-access requests. In other embodiments, however, network-access requests are detected and recorded without using a proxy server. For example, depending on the configuration of the user's computer system, application-program-interface (API) hooking (e.g., the Microsoft® Detours® package) can be used to obtain explicit notifications of network-access requests performed by a user's browser. Although some browsers provide their own APIs, this technique typically requires detailed knowledge of the browser's internal operation, which may be different for each browser and is subject to change without notice. It can therefore be difficult to obtain the desired information directly and unambiguously from the user's computer system. Accordingly, it is often more practical, though not necessary, to use a proxy server inserted into the communication path between the user's browser and the network (e.g., the Web).

The one or more sensors 106 can additionally or alternatively comprise file- and/or operating-system monitors adapted, for example, to record files or applications accessed by a user (referred to herein as “file-activity events”), windows opened or closed by the user, and other such operational data. The one or more sensors 106 can additionally or alternatively comprise monitors adapted to detect the user's keystrokes (e.g., depressions and releases of keys) at the workstation 102 and/or to receive at least some of the user's pointer-device actions (e.g., depressions and releases of mouse buttons). Keystrokes and pointer-device actions are collectively referred to herein as “user-interface events.” This term is not limited, however, and may include other user-initiated actions associated with input/output devices of the workstation 102 (e.g., spoken commands). To detect user-interface events, file-activity events, and window-related events, system-wide “hooking” (e.g., Windows® system-wide hooking) may be utilized. In some situations, a proxy server configured to record file-activity events between a user's workstation and a network server may also be used.

Monitoring software that is run on the user's workstation 102 (or on a connected monitoring computer) can be adapted to receive the output of the one or more sensors 106 and to create one or more lists of user activity. As used herein, the term “list” refers to a collection or arrangement of data that is usable by a computer system. A list may be, for example, a data structure or combination of data structures (such as a queue, stack, array, linked list, heap, or tree) that organizes data for better processing efficiency, or any other structured logical or physical representation of data in a computer system or computer-readable media (such as a table used in a relational database). Moreover, any of the lists discussed herein may be persistent (that is, the list may be stored in computer-readable media such that it is available beyond the execution of the application creating and using the list) or non-persistent (that is, the list may be only temporarily stored in computer-readable media such that it is cleared when the application creating and using the list is closed or when the list is no longer needed by the application).

In one exemplary configuration, the monitoring software captures and records network-access requests (e.g., the URL addresses associated with a Web access), user-interface events, window events (create, destroy, title, activate, etc.), and file-activity events into separate respective lists. These lists may be analyzed separately and afterwards combined into a single list or database of targeted user activities for convenient presentation to the user. In certain embodiments, the monitoring software is further adapted to allow the user to manually enter information about their activities. For example, the user may be able to create entries for non-workstation activities that cannot be recorded automatically by the monitoring software (e.g., meetings with other analysts or non-computer research). The monitoring software may also allow the user to insert explanatory notes regarding any of the user's activities.

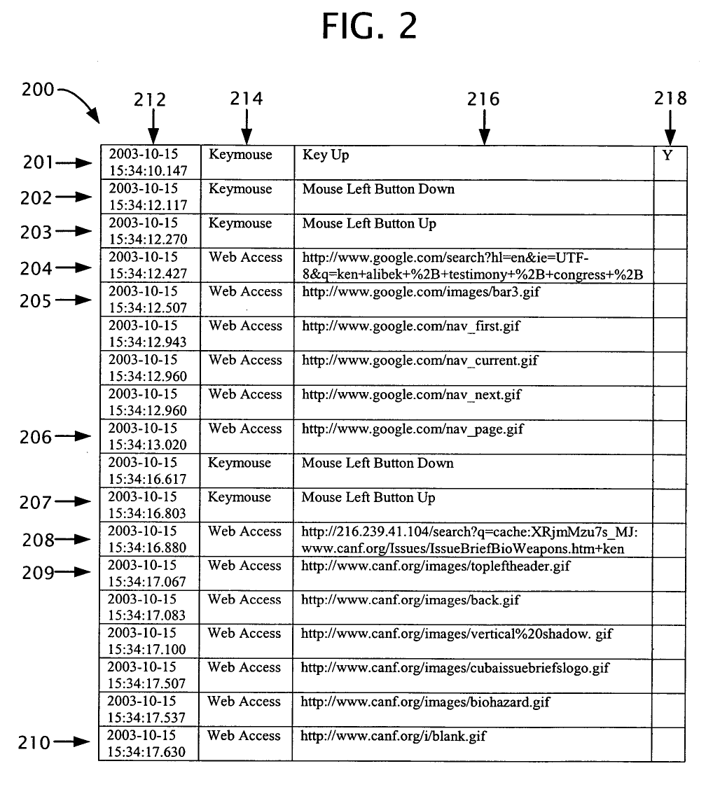

The user activity that is initially detected by the sensors typically comprises one or more raw data streams containing a large amount of irrelevant data. The various entries in the data streams can be time stamped in order to allow the recreation of various actions and responses. The precision with which the data streams are time stamped and/or combined may vary from implementation to implementation, possibly affecting the reliability with which embodiments of the disclosed heuristics operate. Typically, however, relatively precise time stamping is desired (e.g., within a hundredth of a second or within a thousandth of a second). An example of raw data as may be received by the sensors is shown in FIG. 2. In particular, FIG. 2 shows a table 200 comprising both network-access requests (e.g., from a proxy server) and user-interface events (e.g., from system-wide hooking). The data is arranged in a table 200 comprising multiple data entries. The table 200 shows unprocessed, low-level data collected and time-stamped during a period of time when a user entered a Google®-search-engine query for “ken alibek,” “testimony,” “congress,” and “exporting biotechnology,” then clicked on one of the links that was returned. (Many of the preceding keystroke/mouse events are not shown in FIG. 2.) Each entry of the table 200 corresponds to an event detected by the sensors 106 (e.g., a network-access request, a user-interface event, etc.). Further, in the example illustrated in FIG. 2, each entry is characterized by five columns. A first column 212 reports the date and time of the event (in the illustrated embodiment, to the thousandth of a second). A second column 214 describes the type of event that occurred. For example, in the exemplary table 200, the events shown are either a “keymouse” event or a “Web-access” request. A keymouse event corresponds to a user-interface event, such as a keyboard or mouse action, and a Web-access request corresponds to a network-access request performed by the user's workstation (e.g., a URL address requested by a Web browser). A third column 216 describes the event more precisely. For example, if the event is a “keymouse” event, the third column 216 indicates whether the event was a keyboard “up” or “down” action, a mouse wheel action, or a “left” or “right” mouse button action. If the event is a Web-access request, the third column 216 indicates the contents of the request. In FIG. 2, for instance, the third column 216 recites the URL address requested by the user's Web browser. The fourth column 218 indicates the exact value of the recorded keymouse events. The particular manner of presentation shown in FIG. 2 should not be construed as limiting, as the resulting data may be displayed in a variety of different ways (e.g., using different orders, categories, or graphical formats).

As can be seen from FIG. 2, which corresponds to only fifteen seconds of user activity, the amount of raw data collected by the sensors 106 can be quite large, making it difficult and arduous to determine what the user and the computer were doing during this period of time. Accordingly, it is desirable to analyze and filter the data in such a way as to create a meaningful story of what the important activities or events were and what caused certain actions to take place. From this condensed information, one can analyze the user's activity in a more meaningful and efficient manner.

### Exemplary Methods for Analyzing User-Activity Data

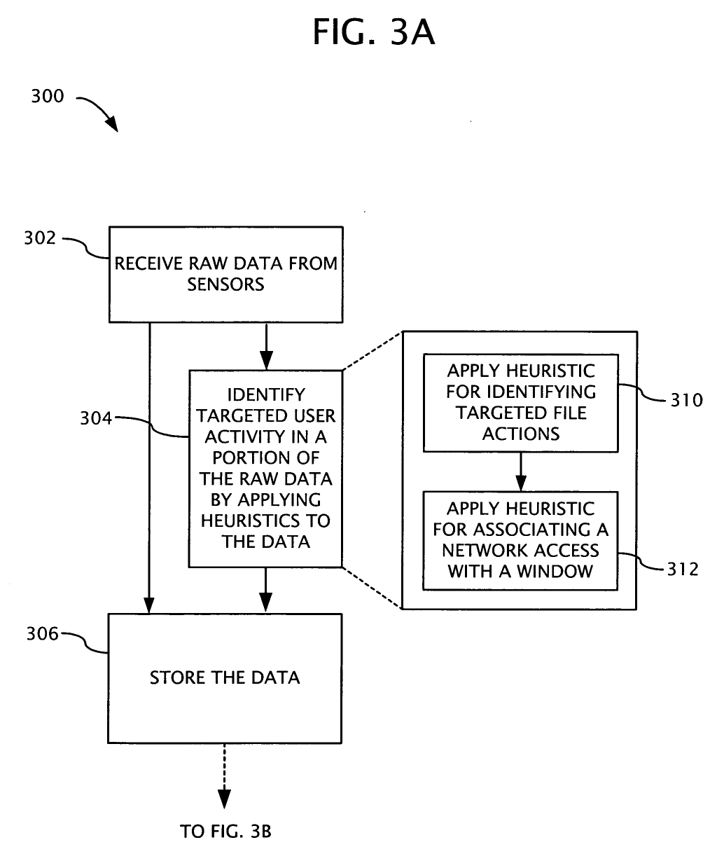

FIGS. 3A and 3B depict a flowchart of an exemplary general method 300 that may be used to monitor and analyze user-activity data so as to produce a condensed list of targeted user activity. At process block 302, raw data is received (e.g., from numerous sensors 106). In this exemplary embodiment, some of this raw data is recorded directly as low-level, user-activity data (e.g., network-access events, user-interface events) to be processed and analyzed later, whereas other portions of the raw data (e.g., file-activity data) are analyzed as soon as or shortly after they are received. At process block 304, for example, targeted user activities can be identified from the raw data using one or more heuristics that are applied substantially concurrently with the data being detected by the sensors. In general, the heuristics comprise problem-solving techniques (which can be implemented as computer-executable instructions stored on computer-readable media) derived from experience in which an appropriate, though not guaranteed accurate, solution is found. The one or more heuristics applied at process block 304 can be adapted to identify certain targeted events in the raw, user-activity data and record only those targeted events, thereby significantly reducing the volume of data that is recorded and/or ultimately presented to the user.

As shown at process block 310 in FIG. 3A, for example, a heuristic can be applied to raw file-activity data to identify targeted file actions. For example, in one particular implementation, the heuristic can combine related file-activity events into single entries that identify the time of the file activity, the file that was accessed during the activity, the process that performed the file-access activity (that is, the application that accessed the file), and the type of action that occurred (e.g., an indication that the user was creating, opening, or modifying the file). Exemplary embodiments of such heuristics are discussed in greater detail below.

As shown at process block 312 in FIG. 3A, a heuristic can be applied that monitors network-access requests and responses, and is configured to associate a window opened at a user's workstation with a particular network-access request. Thus, for instance, whenever the user points to a certain window on their workstation after the heuristic has been performed, information concerning the network-access request (e.g., a URL address) associated with this window can be displayed to the user or otherwise recorded as part of the user-activity data. Exemplary embodiments of such heuristics are likewise discussed in greater detail below.

At process block 306, the data is stored. The data stored can comprise, for example, the targeted data identified by the heuristics at process block 304 as well as data not analyzed at process block 304. For example, in some embodiments, it might be desirable to apply certain heuristics as the relevant data is being received, whereas other heuristics are desirably applied at a later time and possibly by another computer system. The data may be stored in separate lists of user-activity or as lists comprising various combinations and sub-combinations of user-activity data (such as table 200). Further, the data may be transferred to a server computer or transportable computer-readable media such that it can be analyzed later.

Turning to FIG. 3B, additional analysis can be performed on the data recorded at process block 306. This additional analysis can be performed by a different computer system and/or at a later time than the analysis performed at process block 304. At process block 352, at least a portion of the data stored at process block 306 is received. At process block 354, targeted user activities are identified from the stored data by using one or more heuristics. At process block 360, for example, a heuristic can be applied to unprocessed network-access requests obtained from a proxy server in order to identify network-access requests that were initiated by the user (i.e., “user-initiated network-access requests”).

The concept of user-initiated network-access requests can be described in the context of a user browsing the World Wide Web. In this context, a user-initiated network-access request occurs, for example, when the user affirmatively selects to visit a particular Website, say “http://www.cnn.com,” on their Web browser (e.g., by typing the URL address into the browser's address bar and clicking “go” or “enter,” selecting a web page from a “favorites” or “file history” menu, or clicking on a hyperlink or shortcut embedded in a web page or email). This original user-initiated access to www.cnn.com is the event that is desirably identified as “user-initiated.” When a browser visits “www.cnn.com,” however, many other “secondary” URLs are accessed automatically on the user's behalf (e.g., to load images, advertisements, article titles, etc.). For example, one visit to “www.cnn.com” can result in the browser accessing over eighty secondary URLs in addition to the “primary” URL: http://www.cnn.com. Secondary URLs are typically contained in the HTML text sent when the primary URL is accessed and are desirably identified as “non-user-initiated” network-access requests by the heuristic at process block 360. Exemplary embodiments of such heuristics are discussed in greater detail below.

As shown at process block 362, a heuristic can also be applied to the user-activity data in order to identify search queries entered by a user. In one particular embodiment, the heuristic can be adapted to identify search queries made by a user to a search engine on the Web. Thus, if the user searches for the term “United States Patent and Trademark Office” on their Web browser using the Google® search engine, the heuristic can determine not only that a search was made using the Google® search engine, but can identify the specific terms searched. Exemplary embodiments of such heuristics are also described below.

At process block 356, the targeted user activities are output. For example, in certain implementations, the targeted user activities are merged into a single list of targeted user activities that can be output to the user (e.g., via a graphical user interface) or stored in non-volatile computer-readable media. The list of targeted user activities can be created using any combination of targeted user activities identified by the one or more heuristics applied at process blocks 304 and 354. For example, in the context of monitoring a user's Web-browser activity, the list may comprise the primary URLs accessed by the user and/or queries made by the user to Internet search engines. The list may further comprise additional entries corresponding to other targeted user activities, such as targeted file actions (e.g., files opened, modified, or created by the user), user-interface events, and window-change events.

In some embodiments of the disclosed technology, the list of targeted user activities created at process block 306 is stored only temporarily (e.g., in the volatile memory of a computer system or in some other temporary computer-readable media) and thus does not persist once the computer application implementing the method 300 stops running. In other embodiments, however, the list of targeted user activities is stored in non-volatile memory or in some other persistent computer-readable media.

FIG. 4B shows a table 450 of targeted user activities as may be created in process block 356. In particular, the table 450 contains multiples entries, each containing data concerning targeted user activity. A first column 460 shows the date and time of the event. A second column 462 describes the type of event that occurred. For example, in the exemplary table 450, the types of events include user queries to search engines, and Web accesses (e.g., primary URLs visited). A third column 464 shows the application running on the user's workstation in which the event occurred. For example, in the table 450 shown in FIG. 4B, column 464 shows that Microsoft's® Internet Explorer® Web browser was the application being used by the user. A fourth column 466 shows the contents of the network-access request. For example, in the table 450, the fourth column shows the URL addresses accessed by the Web browser. A fifth column 468 may be used to display other relevant information. For example, in FIG. 4B, the fifth column 468 displays the query entered by a user (e.g., “ken alibek” “testimony” “congress” “exporting biotechnology”).

As can be seen from FIG. 4B, the long sequence of keyboard/mouse actions from FIG. 2 has been filtered out and the first Web-access request identified as a query to the Google® search engine (with the query string being parsed out from the URL request). Also, most of the Web accesses from FIG. 2 have been removed because they were identified as non-user-initiated Web-access request by the heuristics. Only the two user-initiated Web-access requests are shown in the table 450.

The particular manner of presentation shown in FIG. 4B should not be construed as limiting, as the resulting data may be displayed in a variety of different ways (e.g., using different orders, categories, or graphical formats). For example, some of the keyboard/mouse actions may be included or summarized in the list.

The number, sequence, and purpose of the heuristics shown in FIGS. 3A and 3B should not be construed as limiting, as they may vary from implementation to implementation and depend on the particular application for which the general method 300 is used. Further, certain heuristics can be performed either as the raw data is received (e.g., at process block 304) or at a later time (e.g., at process block 354). For example, in one implementation, all heuristics are applied as or shortly after the raw data is received by the sensors (e.g., substantially in real time). In such implementations, the monitoring software can be configured to apply all the heuristics to the data detected by the sensors 106, and the list of targeted user activities can be assembled and output at the user's workstation. Additionally, any of the heuristics discussed below can be integrated as part of the other heuristics. That is, the heuristics do not necessarily need to operate independent from one another. In certain embodiments, however, it is desirable for the heuristics to operate independently, as they can be selectively activated or deactivated depending on whether it is desirable to target certain user activities.

### Exemplary Heuristics for Identifying Targeted User Activities

In this section, embodiments of heuristics as may be applied in the general method 300 outlined above are described in greater detail. As noted above, the heuristics are not necessarily limited to the order shown in FIGS. 3A and 3B and can, in certain embodiments, be performed substantially as the raw user-activity data is received at process block 304. Accordingly, the heuristics are not discussed in the sequence illustrated in FIGS. 3A and 3B.

### Heuristics for Identifying User-Initiated Network-Accesses

One exemplary type of heuristic that can be used in the general method 300 shown in FIGS. 3A and 3B is a heuristic for identifying user-initiated network-access requests (as distinguished from network-access requests that are performed on account of instructions received through a previous network access). Because user-initiated network-access requests relate to the network addresses the user intended to access rather than the network addresses that are incidentally accessed, they provide useful and meaningful guidance as to what the user was thinking during the course of their work or activity.

In the context of a user operating a Web browser, for example, there are numerous ways that a user can initiate a Web access. For example, a Web access to a primary URL address can be initiated by a user by: (1) typing the desired URL address into the browser address bar and clicking the “go” button; (2) typing the desired URL address into the browser address bar and hitting “enter”; (3) selecting File|Open from the menu bar of the browser, typing the desired URL address, and clicking “OK”; (4) selecting File|Open|Browse, navigating to a shortcut that contains the desired URL address, and double-clicking it; (5) clicking a hyperlink to the desired URL address in a currently displayed Web page; (6) clicking an “OK” button on a Web page that initiates a hyperlink to a desired URL; (7) clicking a hyperlink to the desired URL address embedded in an email message; or (8) selecting a URL address from a “favorites” or “file history” menu.

In one exemplary implementation, the following simple heuristic can be used for identifying a user-initiated network-access request: “the first network access following a keystroke or mouse click represents a user-initiated network-access request.” This simple heuristic may fail in many different circumstances. For example, in the context of a user browsing the Web, the heuristic will fail when: (1) the user posts a request against a search engine at site S; (2) clicks on one of the hits that is returned to visit site A; (3) clicks the browser's “back” button to review the hit list; and (4) clicks on another hit to visit site B. When the “back” button is pressed, the browser will often reload many URL addresses associated with the search page, but not the primary URL of the search page S itself, as this primary URL is often cached internally by the browser.

This simple heuristic may also fail if the user's Web connection is slow. Consequently, when the user initiates a request to site A, and while that page is loading, the user may, for example, switch to a different window and type into a word processor. The user's keyboard input may then be interleaved with numerous Web-access requests being performed by the browser, thus resulting in spurious instances of Web-access requests being labeled as “user initiated,” when in fact they were not.

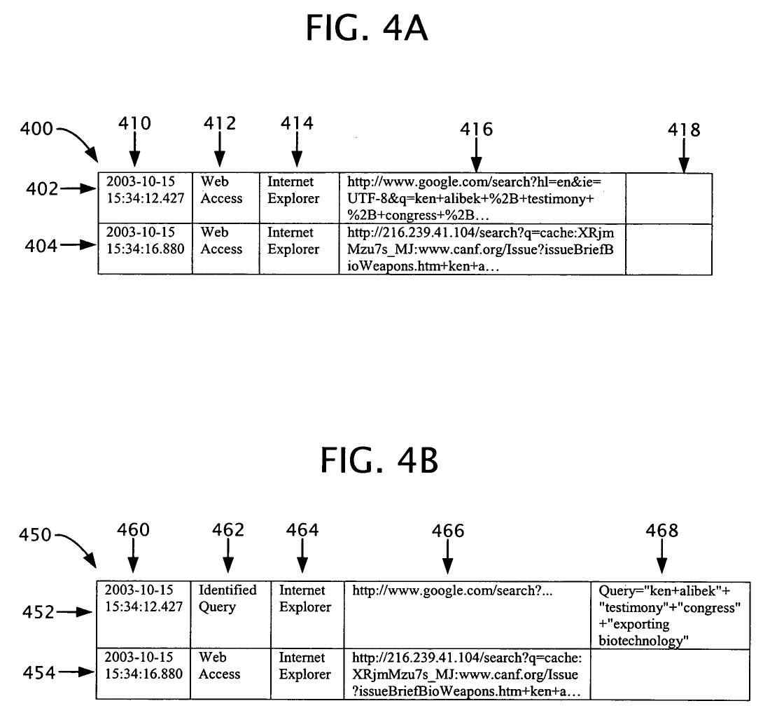

FIG. 5 shows a general method 500 for identifying user-initiated network-access requests from low-level, user-activity data that accounts for the difficulties related to the simple heuristic described above. The general method 500 may be adapted to apply in the context of a user browsing the Web.

At process block 502, user-activity data is received. In this embodiment, it is assumed that the user-activity data received comprises network-access requests (e.g., Web-access requests), user-interface events (e.g., keystroke and mouse actions), and the corresponding times at which these events occurred.

At process block 504, a network-access request that immediately follows a user-interface event is identified. This network-access request may be identified, for example, by ordering the user-activity data chronologically and identifying a network-access request that is immediately subsequent to a user-interface event.

At process block 506, the identified network-access request is compared to network-access requests that are known to be non-user-initiated. The known non-user-initiated network-access requests may be stored in one or more lists. For example, in the context of a user browsing the Web, the one or more lists of non-user-initiated network-access requests may comprise a list of known secondary URL addresses created from empirical information. The list may be updated continuously or periodically with additional non-user-initiated network-access requests. For example, and as explained more fully below, the list can be updated using entries from the user-activity data that are determined to be non-user-initiated. In this way, the list of known non-user-initiated network-access requests grows as the heuristic is being applied.

It should be noted that it is possible for a URL address that is typically a secondary URL address to be used as a primary URL address (e.g., by inserting the secondary URL address into the address bar of a Web browser and clicking the “go” button or hitting “enter”). Such usage, however, is not typical and is not accounted for in the illustrated embodiments. The embodiments may, however, be modified to account for such behavior.

The one or more lists of non-user-initiated network-access requests may also comprise a list of network-access-request types known to be non-user-initiated. In the context of a user browsing the Web, for example, there exist certain URL-address types that are generally known to be non-primary (e.g., a URL-address type not designed to be the first URL address accessed by a Web browser when loading a Web page). For example, URL addresses with extensions such as “.js” (for Java Script) or “.css” (for Cascading Style Sheet) are of a non-primary type. Thus, any URL address containing a “.js” or “.css” extension can be identified as a URL address of a non-primary type. A URL address may contain other information that identifies it as being of a non-primary type. For example, URL addresses to a particular ad server might be designated as being of a non-primary type and included in the list. The list of network-access-request types known to be non-user-initiated typically comprises various network-access-request patterns (which may include one or more wildcard characters) tailored to identify the presence of the targeted information in a file-access request (e.g., “*/*.css/*” where the “*” represents a wildcard character).

Returning to FIG. 5, at process block 508, the identified network-access request is designated as either a “user-initiated” network-access request or a “non-user-initiated” network-access request based at least in part on the comparison performed at process block 506. At process block 510, the user-initiated network-access request is output (e.g., in a list of targeted user activities). The acts of the general method 500 can be repeated as many times as necessary to identify all or some designated number of user-initiated network-access requests from the user-activity data.

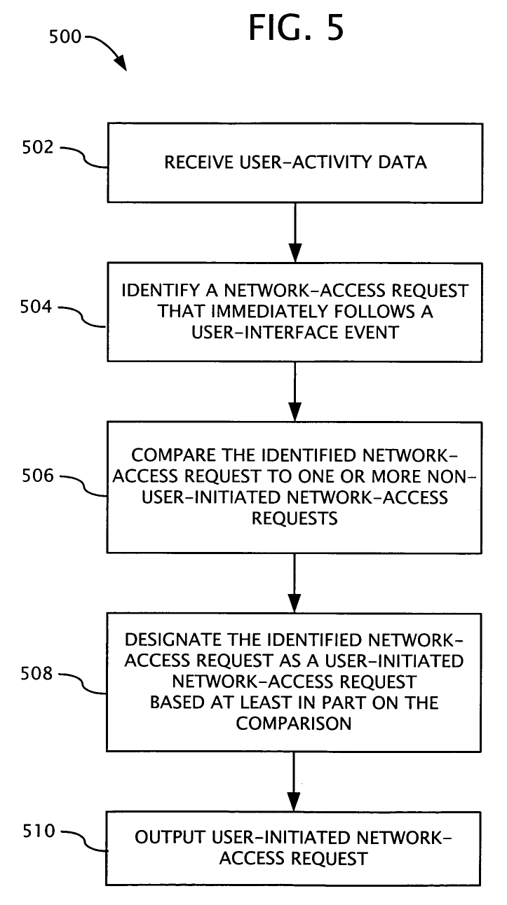

FIG. 6 shows a more specific embodiment of the general method 500 as may be used in the context of a user browsing the Web. For purposes of the embodiment shown in FIG. 6, it is assumed that the user-activity data being analyzed has been previously stored (as in FIG. 3B).

At process block 602, user-activity data that corresponds to a user's activities at their workstation over a specific period of time is received. In this embodiment, the user-activity data comprises Web-access requests (primary and secondary URL addresses accessed by the user's browser), user-interface events (low-level keystroke and mouse-action data from the user's workstation), window events (changes of the active window), and time data as to when each event occurred. The user-activity data received is sorted into chronological order using the time data. In one exemplary implementation, for example, the user-activity data is sorted chronologically from earlier to latest

At process block 603, an indicator flag (termed the “may-be-primary-URL” flag in FIG. 6) is set initially to “false.”

At process block 604, the next entry is selected from the chronologically sorted user-activity data.

At process block 606, a determination is made as to whether the selected entry is a “key-down” or a “mouse-up” event directed to a Web browser. This determination can be made, for example, using the window-event information recorded as part of the user-activity data and is based on the empirical observation that a user-initiated Web access usually occurs either upon the user completing a keystroke (e.g., pressing the “enter” button) or clicking a hyperlink (e.g., releasing the left-mouse button). The user-interface events on which this determination is made, however, may vary from implementation to implementation to account for additional or other user-interface events. If the entry is determined to be a “key-down” or “mouse-up” event, then at process block 608, the “may-be-primary-URL” flag is set to “true” and the method continues to process block 610. Otherwise, the method proceeds directly to process block 610.

At process block 610, a determination is made as to whether the selected entry is a Web-access request. This determination can be made, for example, by recognizing the selected entry as a URL address. If the selected entry is not a Web-access request, then the method proceeds to process block 622, where a determination is made as to whether the selected entry is the last entry. If the selected entry is a Web-access request, then at process block 612 a determination is made as to whether the value of the “may-be-primary-URL” flag is “true.” If the flag is set to “false,” then at process block 614, the selected entry is added to a list of known secondary URLs (such as the one described above with respect to FIG. 5) and the method proceeds to process block 622. In certain embodiments, the list of known secondary URLs is maintained as a non-persistent list that is created each time the heuristic 600 is applied to stored user-activity data.

If process block 612 determines that the flag is set to “true,” however, then a comparison is made at process block 616 to determine whether the selected entry is found in: (1) the list of known secondary URLs; or (2) a list of non-primary URL-address types (as described above with respect to FIG. 5). If the selected entry is not found in either list, then at process block 618, the selected entry is designated as a “user-initiated” Web-access request. In certain embodiments, the selected entry is added to a list of user-initiated Web-access requests that can be output to the user (e.g., at process block 624 discussed below). At process block 620, and in preparation for the next entry to be analyzed, the “may-be-primary-URL” flag is reset to false. If the selected entry is found in one of the lists at process block 616, however, then the “may-be-primary-URL” flag is reset to “false” at process block 620 without designating the selected entry as being user-initiated. In certain implementations, the “may-be-primary-URL” flag is not reset at process block 620 and may be reset at a different time (e.g., after the next entry is selected).

At process block 622, a determination is made as to whether the selected entry was the last entry. If the selected entry is not the last entry, then the method restarts with the next entry at process block 604; if it is the last entry, then the user-initiated Web-access requests are output at process block 624. The user-initiated Web-access requests may be output as part of a list of targeted user activities (such as the list created at process block 356 of FIG. 3B) and presented to the user through a variety of means.

FIGS. 2 and 4A illustrate an exemplary application of the heuristic for identifying user-initiated Web accesses. In particular, FIG. 4A illustrates the application of the method 600 to the exemplary table 200 shown in FIG. 2 (obtained, for example, from a proxy server and by hooking into the user's workstation). Assume that all of the entries shown in FIG. 2 are directed to the Internet Explorer® Web browser operating on the user's workstation.

For purposes of this example, the analysis of the user-activity data in table 200 begins with entry 201. A determination is made that the entry is not a “key-down” or “mouse-up” event directed to a browser (process block 606), or a Web-access request (process block 608). Accordingly, because entry 201 is not the last entry (process block 622), the method 600 is repeated for entry 202.

Entry 202 is a “mouse-up” event (process block 606). Accordingly, the “may-be-primary-URL” flag is set (process block 608). Because the entry 202 is not a Web-access request, the method 600 continued with entry 203 (process blocks 610, 622).

Entry 203 is not a “key-down” or “mouse-up” event directed to a browser (process block 606), but is identified as a Web-access request (process block 610). Further, because the “may-be-primary-URL” flag is set (process block 612), the entry is compared to a list of known secondary URL and known non-primary URL types (process block 616). Assume for purposes of this example that entry 203 is not found in either of the lists. Accordingly, the entry is designated as a “user-initiated Web-access request” (process block 618) and the “may-be-primary-URL” flag is reset to false.

The next entry, entry 205, is also identified as a Web-access request (process block 610), but the “may-be-primary-URL” flag is identified as being set to “false” (process block 612). Accordingly, the entry 205 is deemed to be a secondary URL and is added to the list of known secondary URLs (process block 614). The next few entries, through entry 206, are similarly identified as being secondary URLs, and are all added to the list of known secondary URLs.

With entry 207, the entry is identified as a “mouse-up” event directed to a browser (process block 606). Accordingly, the “may-be-primary-URL” flag is set (process block 608).

Entry 208 is then recognized as a Web-access request (process block 610). Further, because the “may-be-primary-URL” flag is set (process block 612), the entry is compared to the lists of known secondary URLs and known non-primary types (process block 616). Assume for purposes of this example that entry 208 is not found in either list. Accordingly, the entry 208 is designated as a “user-initiated Web-access request” (process block 618) and the “may-be-primary-URL” flag is reset (process block 620).

Because the “may-be-primary-URL” flag is reset to false and there are no intervening “key-down” or “mouse-up” events directed to a browser, the next few entries are determined to be secondary URLs, which are added to the list of known secondary URLs. After entry 210 is analyzed using the method 600, the user-initiated Web-access requests are output (process block 624).

FIG. 4A shows an exemplary table 400 of the user-initiated Web-access requests identified using the method 600 and output at process block 624. In particular, the table 400 contains multiples entries, wherein each entry contains data concerning the targeted user activity. A first column 410 shows the date and time of the event. A second column 412 describes the type of event that occurred (e.g., a “Web access” event). A third column 414 shows the application running on the user's workstation which performed the event. A fourth column 416 shows the Web-access request in terms of its URL address. As described below, a fifth column 418 may be used to display other relevant information.

The heuristic described above does not necessarily need to operate in the sequence shown above, as certain described operations may in some cases be rearranged or performed concurrently. Moreover, the particular titles of the various lists and flags described above should not be construed as limiting, as they may change from implementation to implementation. Additionally, the heuristic can be modified in several respects to identify other types of user-initiated Web accesses. For example, the heuristic can be modified to account for the situation where a user visits a page by clicking on a hyperlink in an email or a word processing document.

### Heuristics for Identifying User Queries

Another exemplary type of heuristic that can be used in the general method 300 shown in FIGS. 3A and 3B is a heuristic for identifying user queries—for example, a user query to a search engine on the Web. Like the user-initiated network-access requests discussed above, user queries can provide useful and meaningful insight as to what the user was thinking during the course of their work.

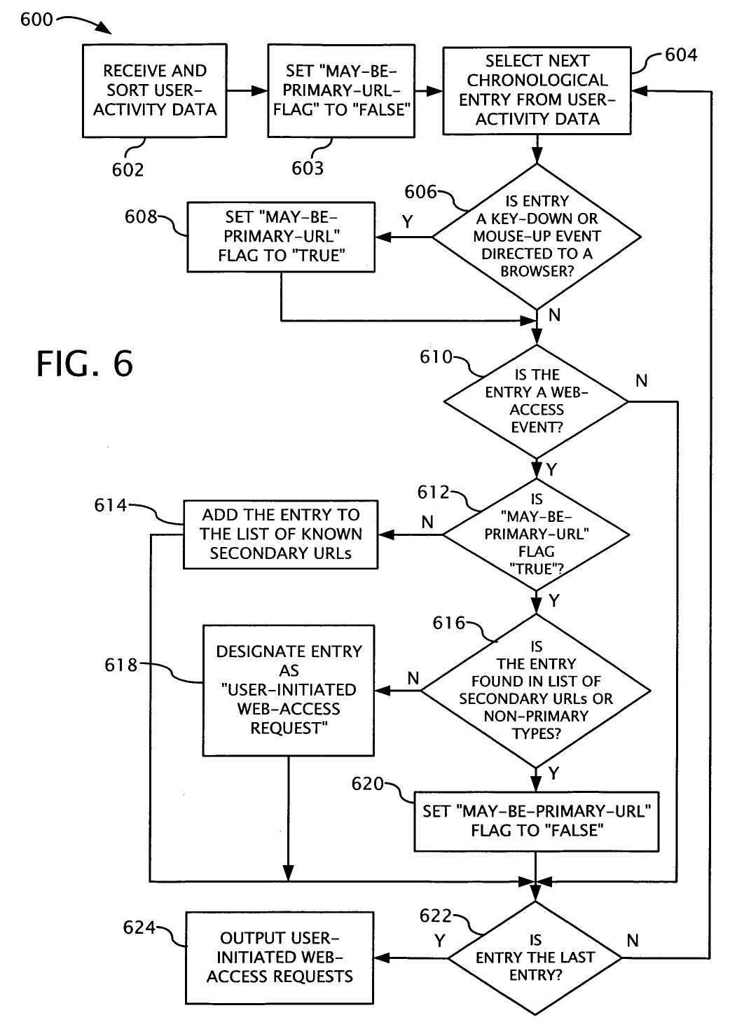

FIG. 7 shows a general method 700 for identifying user queries to a network search engine. The general method 700 may be adapted to apply in the context of a user browsing the Web.

At process block 702, user-activity data is received. The user-activity data typically includes network-access requests (e.g., Web accesses), user-interface events (e.g., keystroke and mouse actions), and the corresponding times at which they occurred. The user-activity data may also comprise user-activity data that has been previously analyzed by another heuristic (e.g., the targeted user-activity data from table 400 in FIG. 4A).

At process block 704, a network-access request is selected from the user-activity data and compared to known search-engine-query addresses. The network-access request may be selected because it has some recognized format or simply because it is the next network-access request to be considered from the user-activity data. The known search-engine-query addresses may be stored in a list that is compiled empirically and that may be periodically updated to account for newly discovered or released search-engine-query addresses. The search-engine-query addresses relate generally to network-access requests that are recognized by their form to comprise a search-engine query. For example, in the context of a search engine used to search the Web, the search-engine-query addresses correspond to URLs used by known search engines to execute search queries. The Google® search engine, for example, typically uses the URL “http://www.google.com/search?h1=en&ie=UTF-8&q=user+query,” where the words “user+query” in the URL correspond to the terms searched for (here, “user query”). The search terms contained in the URL may be ignored for purposes of matching the URL to the selected network-access request.

At process block 706, the user's query is identified based at least in part on the comparison from process block 704. In general, once the search-engine-query addresses are known, the location of the user query within the address can be identified such that the user query itself can be extracted. In certain embodiments, procedural and declarative codes can be written that parse each of the URLs (using, for instance, a separate pattern for each search engine). Because the formats of these search engine URLs are often unpublished, it may be necessary to reverse engineer the format by manually issuing queries against each engine and observing how the HTTP, GET, and POST requests change as a result. This reverse engineering may be performed manually or automatically. At process block 708, the user's query is output (e.g., in a list of targeted user activities)

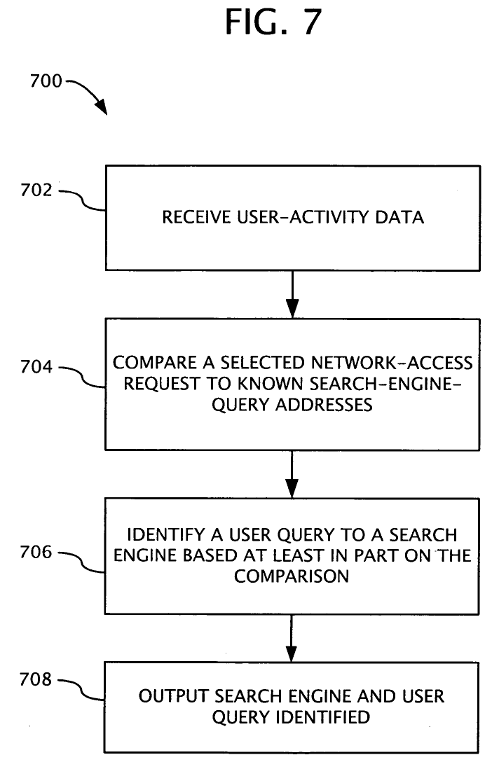

FIG. 8 shows a more specific embodiment of the general method 700 that can be used to identify user queries to a search engine in the context of a user browsing the Web. At process block 802, user-activity data is received that corresponds to a user's activities at their workstation. In this embodiment, the user-activity data comprises Web-access requests (e.g., primary and secondary URL addresses accessed by the user's browser), user-interface events (e.g., low-level keystroke and mouse-action data from the user's workstation), and time data as to when each event occurred.

At process block 804, the next event is selected from the user-activity data. Though not necessary, the user-activity data may be sorted (e.g., chronologically using the time data).

At process block 806, a determination is made as to whether the selected entry is a Web-access request. This determination can be made, for example, by recognizing the selected entry as a URL address. If the selected entry is not a Web-access request, then a determination is made at process block 812 as to whether the selected event is the last event. If it is not, then the method returns to process block 804, where the next entry from the user-activity data is selected.

If the selected entry is a Web-access request, then at process block 808, a determination is made as to whether the selected entry is found in a list of known search-engine-query URLs (described above). If the entry is not found in the list of known search-engine-query URLs, then the selected entry is presumed to not be a query to a search engine, and the method proceeds to process block 812. If the entry is found in the list, then the user query is identified at process block 810 using the matching URL from the list (e.g., by parsing the query from the selected entry according to the pattern of the matching URL address).

At process block 812, a determination is made as to whether the selected entry is the last entry in the user-activity data received. If it is not, then the method 800 is repeated with the next entry at process block 804. If the selected entry is the last entry, then the user queries and search engines identified are output at process block 814. For example, the queries and the corresponding search engines may be added to a list of targeted user activities (such as the list created at process block 356 of FIG. 3B) and presented to the user through a variety of means.

FIGS. 4A and 4B illustrate an exemplary application of the heuristic for identifying user queries to search engines. In particular, FIG. 4B illustrates the application of the method 800 to the list of user-initiated Web-access requests produced by the method 600 and described above with respect to FIG. 4A. In this manner, the method 800 is used to further filter or analyze the targeted user-activity data. It should noted, however, that the method 800 can be applied to unprocessed user-activity data or, in some embodiments, be combined with the method 600 to form a single heuristic for identifying user-initiated, Web-access requests and user queries.

Beginning with entry 402 from table 400, it is determined that the entry is a Web-access request (process block 806). For purposes of this example, assume that the list of known search-engine-query URLs includes an entry for the Google® search engine (e.g., http://www.google.com/search?h1=en&ie=UTF-8&q= . . . ). Accordingly, the entry 402 is found in the list of known search-engine-query URLs (process block 808) and the user query is identified (process block 810). Specifically, the user query to “ken alibek,” “testimony,” “congress,” and “exporting biotechnology” is identified. Because entry 402 is not the last entry, the method 800 is repeated for entry 404.

For entry 404, the entry is not found to be in the list of known search-engine-query URLs (process block 808). Accordingly, no search engine query is identified. The search engine and user query are then output (process block 814).

FIG. 4B shows one exemplary manner in which the search engine query and corresponding search engine can be output. In particular, and as described above, FIG. 4B is a table 450 of targeted user activity, which includes a first entry 452 that includes the fifth column 468, which displays the query entered by the user (“ken alibek,” “testimony,” “congress,” and “exporting biotechnology”). In this particular embodiment, the first entry 452 replaces the previously created entry 402 from FIG. 4A, but the second entry 454 remains unchanged from the entry 404 shown in FIG. 4A.

The heuristic described above does not necessarily need to operate in the sequence shown above, as certain described operations may in some cases be rearranged or performed concurrently.

### Heuristics for Identifying Targeted File Actions

Another exemplary type of heuristic that can be used in the general method 300 shown in FIGS. 3A and 3B is a heuristic for identifying targeted file actions—for example, the creation of a new file or the opening of an existing file by a user. Like the user-initiated network-access requests discussed above, information about how and when a user created, opened, and modified files can provide useful and meaningful insight as to what the user was thinking during the course of the user's work. For purposes of this discussion, it assumed that the heuristic is applied at process block 304 as or shortly after the relevant user-activity data is detected by the sensors 106. The heuristic can be modified, however, to be performed at a later time.

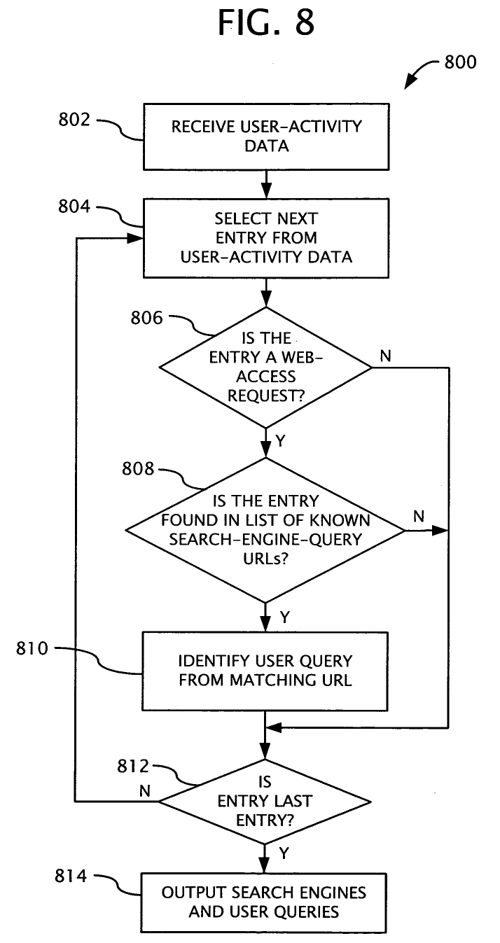

FIG. 9 shows a general method 900 for identifying targeted file actions performed at a user's workstation. For example, in the disclosed embodiment, the general method analyzes raw, file-activity data to determine whether the data corresponds to a user opening, modifying, or creating a file.

At process block 902, user-activity data is received. In this embodiment, it is assumed that the user-activity data received comprises raw, file-activity data as can be detected through a workstation's file- or operating-system sensor 106 (e.g., using system-wide hooking). In one exemplary form, each file-activity event detected identifies at least: (1) the time of the event; (2) the file that was accessed during the event; and (3) the process accessing the file. As used herein, the term “process” refers to an instance of a running program (e.g., an instance of a software application running on the user's workstation).

Typically, a simple file action (such as opening a new file) can generate dozens of low-level, file-activity events (such as accessing temporary or system files or repeatedly accessing the file during execution of the action). These irrelevant and spurious low-level, file-activity events are desirably filtered such that only acts indicative of what file action the user intended to do are listed.

At process bock 904, file-activity events that are known to be irrelevant are removed from the file-activity data. For example, a file-activity event can be removed if it matches an entry in a list of exclusion patterns. An exclusion pattern can comprise any feature or trait of the file-activity event that identifies the event as being one that is related to an irrelevant file. In one implementation of the method 900, for example, any file-activity event related to a file stored in a temporary folder is desirably excluded. Thus, the exclusion patterns might comprise: “*\Temporary Internet Files\*,” “*\Documents and Settings\Temp\*,” or “*\Documents and Settings\ . . . \Application Data\*,” (where the “*” represents a wildcard character). Likewise, the exclusion pattern can be tailored to target and remove file-activity events related to a specific process that is deemed to be irrelevant. Thus, for example, any access of a file performed by an instance of Explorer® (the file-system indexing service used in Windows®) or Internet Explorer® might be removed from the raw file-activity data received.

At process block 906, the remaining file-activity events are clustered together into larger periods of activity. For example, file-activity events that involve the same process and file, and that occur within predetermined time intervals of one another, are combined into a cluster (referred to herein as a “process-file cluster”.) In one exemplary implementation, for instance, file-activity events are aggregated into a common process-file cluster if each event indicates an access by the same process, to the same file, occurring within N seconds (e.g., five seconds) of the previous event in the cluster. The interval of time that may elapse between events to be clustered may vary from implementation to implementation and can be derived empirically, or from statistical analysis or simulation. Conceptually, the process-file clusters collectively represent a single file action that occurred over a period of time. Thus, for the embodiment described above, a process-file cluster can be viewed as indicating that process P accessed file F at time T₁, and continued to access the file F at least once every N seconds until the access at time T₂, at which time it stopped accessing the file F for at least N seconds.

At process block 908, the process-file clusters are analyzed relative to when the file that was accessed was created and/or last modified. More specifically, a time associated with the process-file cluster (e.g., the time of the first file-access event in the cluster) is compared to the creation and/or modification times of the file accessed. The creation and/or modification time of the file is typically stored by the operating system of the user workstation. For instance, for a workstation using the Windows® operating system, the operating system can be queried once a process-file cluster is created to determine what dates and times the operating system has stored as the “last modification” and “creation” times for the file accessed during the process-file cluster.

At process block 910, the process-file clusters are classified as representing different types of file actions based at least in part on the comparison performed at process block 908. For example, according to one implementation, for a selected process-file cluster, if the first event in the cluster occurred after a threshold time period from the last modification (referred to herein as the “modification-time threshold”), then the file action represented by the process-file cluster is classified as an “opening” action (that is, the cluster is deemed to represent the opening of a file). On the other hand, if the first event in the cluster occurred within the modification-time threshold, then the process-file cluster is classified as either representing a “creation” action or a “modification” action. Specifically, if the first event of the cluster occurred after a threshold time period from the creation of the associated file (referred to herein as the “creation-time threshold”), then the file action represented by the cluster is classified as a “modification” action; otherwise, the file activity is classified as a “creation” activity.

At process block 912, the file actions performed during the process-file clusters are output. For example, in certain embodiments, the file actions are included in a list of targeted file actions, which can be combined with other user activities into a single list of targeted user activities.

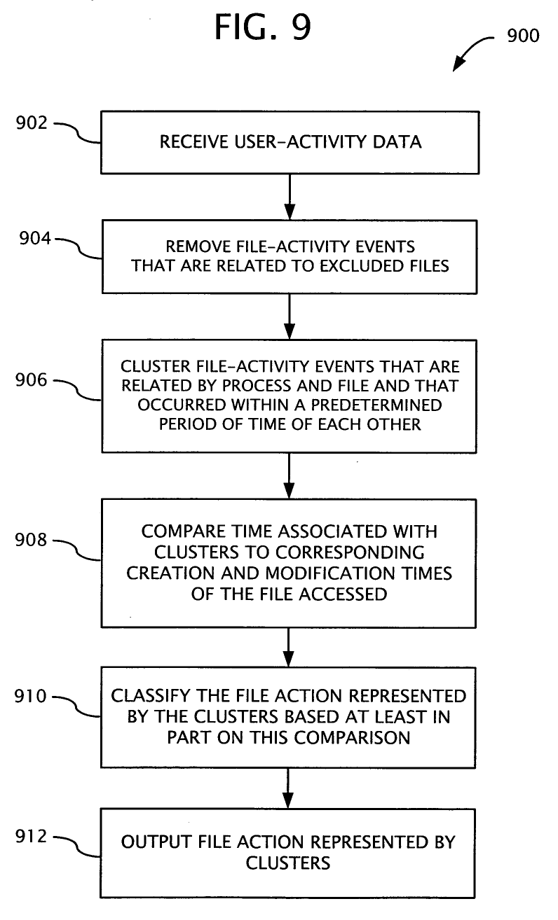

FIGS. 10A and 10B show a more specific embodiment 1000 of the general method 900 that can be used to analyze raw, file-activity data and identify targeted file actions. For purposes of this exemplary method, it is assumed that the file-activity events are analyzed substantially concurrent to when they are received, or shortly after they are received, by the sensors 106 (e.g., substantially in real-time). At process block 1002, a file-activity event is received. At process block 1004, a determination is made as to whether the file-activity event is related to any excluded files (e.g., by comparing the event to a list of exclusion patterns). If the file-activity event is related to an excluded file, then it is removed from further consideration (e.g., deleted) at process block 1005. At process block 1006, a determination is made as to whether the event involves the same file and process as a previous file-activity event or cluster. If so, then the method 1000 continues at process block 1008; otherwise, the method 1000 proceeds to process block 1012. At process block 1012, a determination is made as to whether the event is associated with a window. For example, other user-activity data can be monitored to determine whether a window title change occurred near the time of the event (e.g., within five seconds of the selected event) and any window title change detected can be compared to the name of the file accessed during the event to determine whether the names are at least partially identical. If a matching window title change is found, then, according to one embodiment, the event is flagged as having “appeared in a window title”; otherwise, the event is flagged as “not appearing in a window title.”

Returning to process block 1008, a determination is made as to whether the file-activity event occurred within a specified period of time of the previous file-activity event or cluster identified as having the same process and file (measured, for example, from the last event in the cluster). The period of time used at process block 1008 may vary from implementation to implementation, but in one exemplary implementation is five seconds. If the file-activity event did occur within the specified period of time, then, at process block 1010, the event is combined with the previous file-activity event or cluster. That is, if the selected event occurred within the specified period of time of a previous matching event, then the two events are combined into a single process-file cluster; and if the selected event occurred within the specified period of time of a previous matching cluster, then the selected event is added to the cluster. The method 1000 then proceeds to process block 1012, where the cluster is associated with a window.

At process block 1014, a determination is made as to whether any events or process-file clusters are ready to be classified. In certain implementations, an event or cluster is ready for classification when it has been unchanged for a fixed period of time (e.g., five seconds). For example, when a cluster has had no new file-activity events added to it for a period of five seconds, it is deemed to be complete and ready for classification. Process block 1014 can be performed substantially continuously (e.g., at constant intervals) during execution of the method 1000. When an event or cluster is ready to be classified, the method 1000 proceeds to process block 1020 shown in FIG. 10B.

At process block 1020, the creation and modification times for the file associated with the event or process-file cluster to be classified are determined. This information is typically stored by the operating system of the user's workstation and can be obtained by querying the operating system. At process block 1022, a determination is made as to whether the event or the cluster occurred within a modification-time threshold (e.g., five seconds) of the modification time obtained at process block 1020. If so, then the method 1000 continues at process block 1026; otherwise, a determination is made as to whether the event or cluster is associated with a window (as was determined at process block 1012). If the event or cluster is associated with a window, then the file action represented by the event or cluster is designated as being an “opening” action (i.e., representative of the user opening a file). This classification, as well as other information concerning the file action, can then be output (e.g., in a list of targeted file actions or a list of targeted user activities) and the method can return to process block 1002 of FIG. 10A.

Returning to process block 1026, a determination is made as to whether the event or cluster occurred within a creation-time threshold (e.g., one minute) of the creation time obtained at process block 1020. If so, then the file action represented by the event or cluster is classified as a “creation” action (i.e., representative of the user creating a file); otherwise, if the event or cluster occurred after the creation-time threshold, then the file action is output as a “modification” action (i.e., representative of the user modifying a file).

The heuristic described above does not necessarily need to operate in the sequence shown above, as certain described operations may in some cases be rearranged or performed concurrently. Moreover, the particular titles of the various lists and flags described above should not be construed as limiting, as they may change from implementation to implementation. Additionally, the heuristic can be modified in several respects to identify other types of targeted file actions. For example, an “inclusion” list may be utilized to record events that would be classified as “open” events were they associated with a window title change.

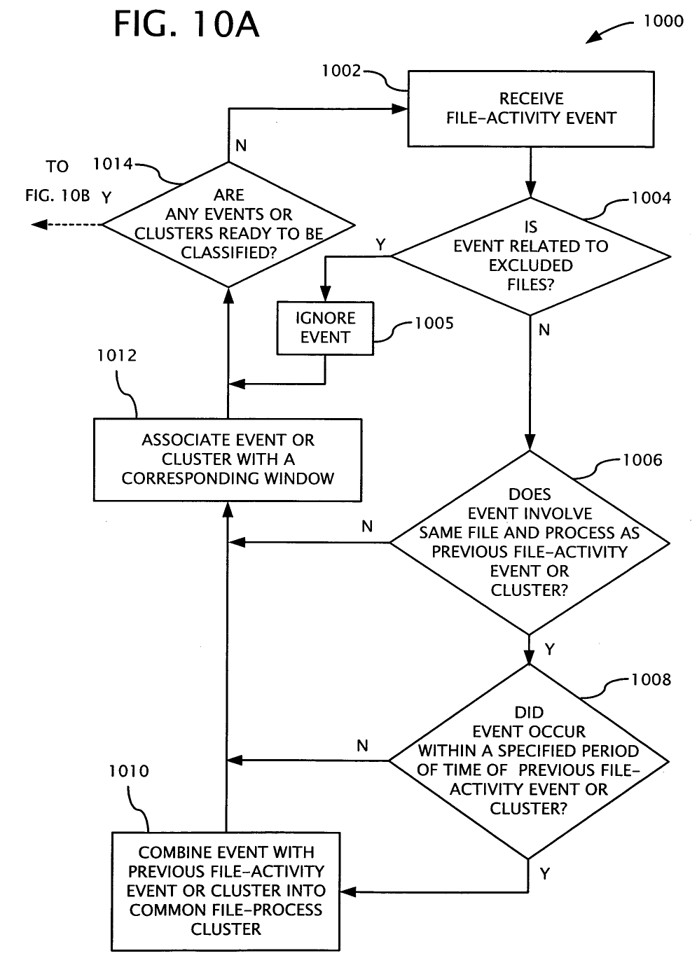

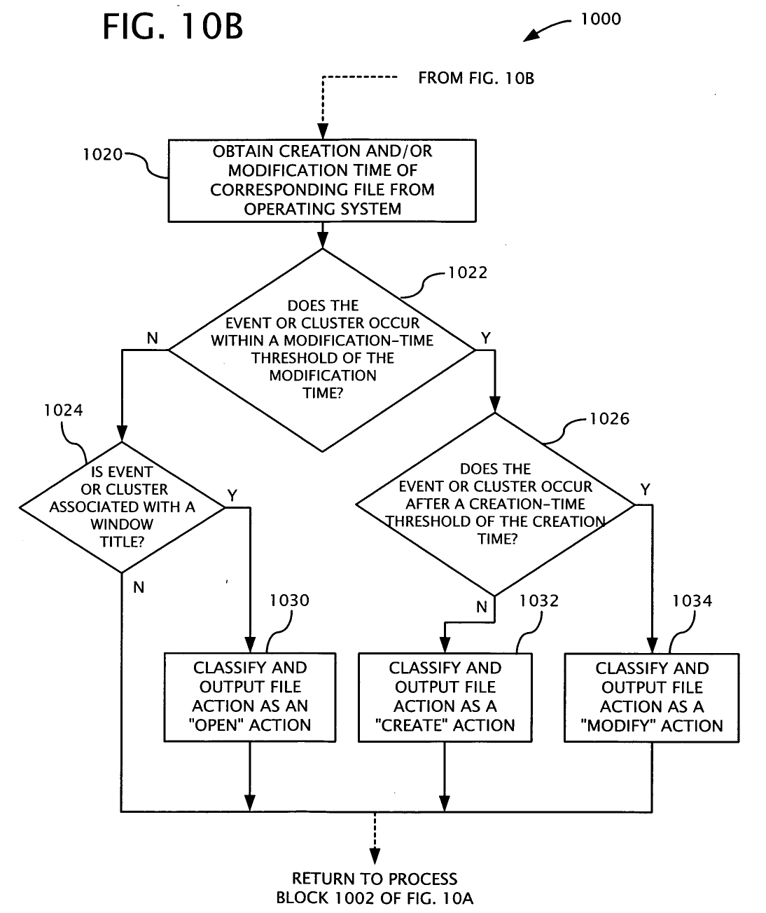

FIGS. 11 and 12 illustrate an exemplary application of the heuristic for identifying targeted file actions. In particular, FIGS. 11 and 12 illustrate the application of the method 1000 to an exemplary set of raw, file-activity data. FIG. 11 is a table 1100 comprising low-level, file-activity data, wherein each entry corresponds to a file-activity (or file-access) event. It is assumed for illustrative purposes that all of the file-activity events in table 1100 are not related to excluded files. The entries in the exemplary table 1100 are chronologically ordered and show the time of the event in column 1102 and selected information concerning the file-activity events in column 1104 as may be obtained from an operating-system sensor. In relevant part, the information in column 1104 includes the name of the file accessed (here, “LoggingArchitecture7.doc” from the tree “C:Documents and Settings\d39135\My Documents\”) and the name of the process that accessed the document (here, “WINWORD.EXE,” or Microsoft's® Word® word processor).

The first entry 1110 in the table 1100 occurred at 17:36:55.513 and was followed by numerous other accesses (represented by entry 1111 and the subsequent ellipses) until entry 1112 at 17:36:55.919. Then, as shown in entry 1120, the file was accessed again at 17:37:28.341, after which time numerous additional accesses to the file occurred (entry 1121 and the subsequent ellipses) until entry 1122 at 17:37:28.372. The next file access is shown in entry 1130 as occurring at 17:37:35.122, which was followed by numerous additional accesses (entry 1131 and the subsequent ellipses) until entry 1132 at 17:37:35.513. The additional file accesses that are represented by the ellipses are typically numerous in quantity and comprise a large amount of file-activity data that is desirably grouped together or ignored by the heuristic.

Beginning with the first file-activity event in entry 1110, it is determined that the event is not related to any excluded files (process block 1004) and does not involve the same file or process as any previous file-activity event because it is the first file-activity event (process block 1006). An evaluation is made as to whether the event is associated with a window (process block 1012). This evaluation can be performed, for example, by monitoring for any window title changes that occur within a fixed amount of time of the selected event (e.g., within two seconds). Assume for purposes of this example that the event is associated with a window title change. That is, assume that the name of the file accessed (“LoggingArchitecture7”) matches the name in a title bar of a window that was changed near the time of the selected event (e.g., within two seconds). A determination is made as to whether any events or clusters are ready to be classified (process block 1014). Assume for purposes of this example that events or clusters are to be classified if they have not been combined with any other events for more than five seconds. Thus, at this point in the example, no events or clusters are ready to be classified.

When the next entry 1111 is received, it is determined that the event is not related to any excluded files (process block 1004) and that the event involves the same file and process as a previous file-activity event or cluster, namely event 1110 (process block 1006). It is also determined that the event at entry 1111 occurred within a specified period of time of the previous event, which is assumed to be five seconds or less for purposes of this example (process block 1008). Thus, the event at entry 1111 is grouped into a common process-file cluster with entry 1110 (process block 1010). A window is already associated with the cluster (process block 1012), and no event or cluster is ready yet for classification (process block 1014).

The method 1000 continues to build the first process-file cluster until entry 1112. Five seconds after the first process-file cluster is complete, it is determined that the first cluster is ready for classification because it has not been combined with any other event for the specified period of time (process block 1014). Turning now to FIG. 10B, the operating system is queried to determine the creation and last modification times stored for the file (process block 1020). For purposes of this example, assume that the creation time and the last modification time both occurred the day before (e.g., creation time: Aug. 12, 2004, 15:30:00; last modification time: Aug. 12, 2004, 17:30:00). Also, for purposes of this example, assume that the modification-time threshold is five seconds and that the creation-time threshold is one minute. Thus, the first file-activity event in the cluster did not occur within the modification-time threshold (process block 1022). Because the cluster is associated with a window (process block 1024), it is classified as being indicative of the file being “opened” (process block 1030). This classification, as well as other information related to the file action that the first process-file cluster represents, is output and possibly recorded in a list of targeted file actions or a list of targeted user activities.

The method 1000 continues in this manner for the next entries (entries 1120-1122) and builds a second process-file cluster. When the second cluster is ready to be classified (process block 1014), the operating system is again queried for the creation time and last modification time. Assume now that the creation time is unchanged, but that the last modification time is Aug. 13, 2004, 17:37:28.350. Thus, the first file-activity event in the second cluster (entry 1120) occurred within a modification-time threshold (process block 1022), but after a creation-time threshold (process block 1024). Thus, the second process-file cluster is classified and output as indicating the “modification” of the file (process block 1034).

For the next entries (entries 1130-1132), a third process-file cluster is built. Assume now that no window is associated with this third process-file cluster (that is, no window title change is found to have occurred within two seconds of any of the entries 1130-1132). When the third process-file cluster is ready for classification (process block 1014), the operating system is again queried for the creation and modification time of the file. Assume that the creation and modification time is unchanged from when it was queried for the second cluster. Thus, the first file-activity event in the third cluster did not occur within the modification-time threshold (process block 1022) and is not associated with a window (process block 1024). Consequently, no file action associated with the third process-file cluster is output. For example, the file may have been moved or deleted, events that the exemplary method 1000 does not record.

FIG. 12 shows one exemplary manner in which the targeted file actions can be output. In particular, FIG. 12 shows an exemplary table 1200 of the file actions identified from the table 1100. A first column 1202 shows the date and time of the targeted file action. A second column 1204 describes generally the type of event that occurred (e.g., a “file access” event). A third column 1206 shows the process running on the user's workstation that performed the file access. A fourth column 1208 shows the location of the file that was accessed during the file action. A fifth column 1212 shows the classification of the file action as determined, for example, by the method 1000. Thus, for the example discussed above, the first cluster is represented in entry 1220 and is classified as an “open” action; whereas the second cluster is represented in entry 1221 and is classified as a “modify” action.

The heuristic described above does not necessarily need to operate in the sequence shown above, as certain described operations may in some cases be rearranged or performed concurrently.

### Heuristics for Associating a Network Access with a Window

Another exemplary type of heuristic that can be used in the general method 300 shown in FIGS. 3A and 3B is a heuristic for associating a network-access request (e.g., a URL address) with a particular window opened on the user's workstation. Information about the network-access request associated with a particular window can be useful to produce a better record of user-activity data. For example, according to one embodiment, when the user points to a particular window on their screen, the associated URL can be shown to the user (e.g., in a line above the window). The user can also use this association to input their own comments about the network-access request (e.g., comments about the relevance of a particular web page), which can then be made part of the targeted user-activity data.

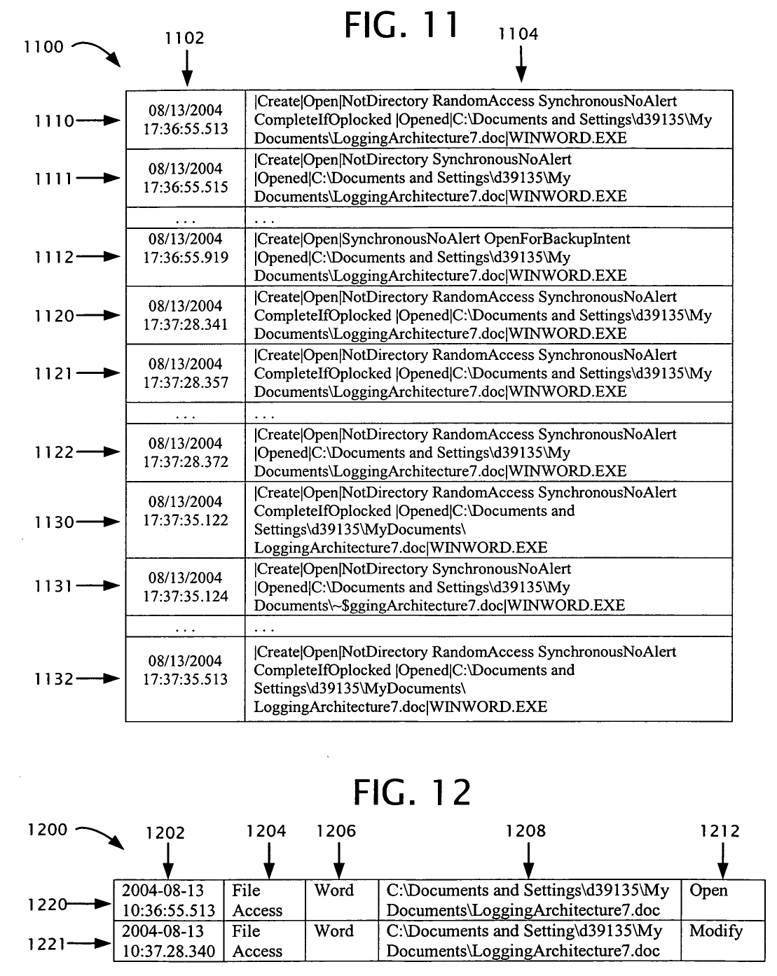

FIG. 13 shows an exemplary method 1300 for associating a network-access request with a particular window opened on the user's computer. In particular, the method can receive raw, network-activity data (including network-access requests and the network responses thereto) from a proxy server (e.g., an HTTP-level proxy) monitoring a workstation's Web-browser activity.

At process block 1302, the network responses to the network-access requests from a user's workstation are monitored. At process block 1304, a network response directing a window title change is identified. For example, the network responses being monitored can be searched to determine whether they contain any directives to change a window title on the user's workstation. For example, in the context of monitoring a user's Web browser activity, the directive might comprise an HTML field that prompts a window title change in the user's Web browser (e.g., “<title> . . . </title>”).

At process block 1306, a window having a title that changed within a selected period of time of the network response directing the window title change is identified. For example, the data being received by an operating-system sensor (e.g., using system-wide hooking) can be monitored to see if a window title on the user's workstation changed within a selected period of time from receipt of the identified network-response (e.g., two seconds).

At process block 1308, the title of the window identified is compared to the title directed by the identified network-response. If the titles match, then the window is associated with the network-access request that produced the identified network response.

In one particular embodiment, after this association is made, the user can point to an active window on their workstation and have the network-access request (e.g., the URL address) associated with the window be included as part of any user-activity data recorded. The user may additionally be able to insert additional comments concerning the network-access request, which also becomes part of the user-activity data recorded. For instance, an operating-system sensor can be used to monitor a user's pointer-device (e.g., mouse) coordinates on a screen and to identify the window to which the user is pointing. The network-access request associated with this window can then be displayed to the user or recorded as part of the user-activity data, and, in some embodiments, the user can enter additional information about their activities related to the associated network-access request. As part of this feature, for instance, the user can point to a window and select to make a note about the contents in the window. Because the window can be associated with a particular network-access request using the general method 1300, the user's commentary can be associated not just with a particular window and window title, but with a particular network-access request (e.g., a URL address).

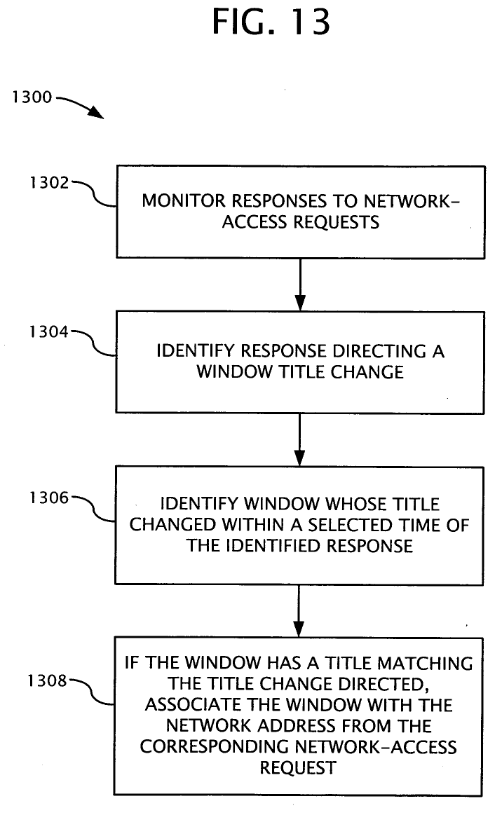

FIG. 14 shows a more specific embodiment of the general method 1300 as may be used to associate a URL address with a window on the user's workstation as the user is browsing the Web. The method 1400 can be performed on data at substantially the same time the data is produced (i.e., substantially in real-time). Alternatively, the method 1400 can analyze previously recorded user-activity data. At process block 1402, an Internet response to a Web-access request is received (e.g., from a proxy server used to monitor all Web-access requests). At process block 1404, a determination is made as to whether the Internet response includes a directive to change a window title (e.g., the HTML field: “<title> . . . </title>”). If the Internet response has such a directive, the process continues at process block 1406; otherwise, the method 1400 returns to process block 1402, where the next Web-access request is received. At process block 1406, a determination is made as to whether a window title change occurred within a predetermined period of time of the directive. This time period is desirably long enough to monitor all window title changes that reasonably could have resulted from the directive. If a window title change is found within the threshold amount of time, then the process continues at process block 1408; otherwise, the method 1400 returns to process block 1402. During this period of time, multiple window title changes may have occurred. In such situations, and according to one embodiment of the method 1400, each of the window title changes observed is analyzed at process block 1408. At process block 1408, a determination is made as to whether the window title change found matches the title change in the HTML directive. If a match is found, then at process block 1410, the URL address associated with the Internet response received is associated with the matching window; otherwise the method 1400 returns to process block 1402.

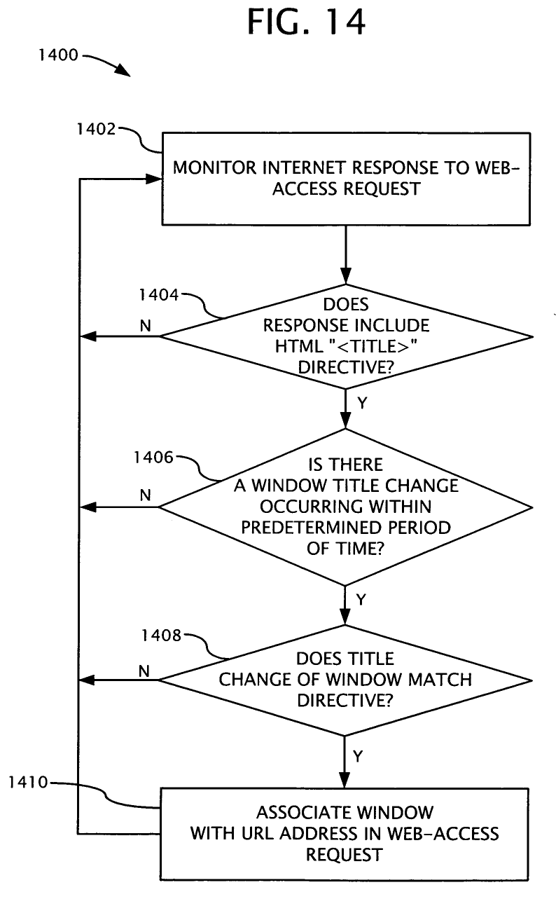

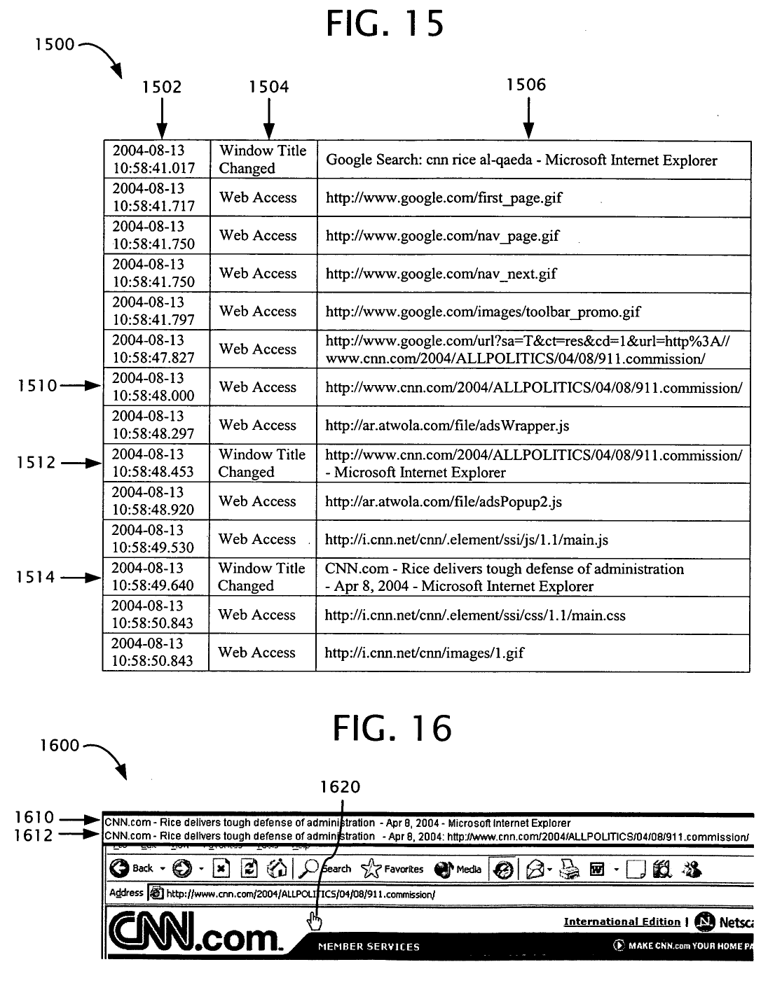

FIGS. 15 and 16 illustrate an exemplary application of the heuristic for associating a network-access request with a window on the user's workstation. In particular, FIGS. 15 and 16 illustrate the application of the method 1400 to exemplary Web-browsing activity. FIG. 15 is a table 1500 comprising Web-access requests (e.g., obtained from a proxy server linked to the user's computer), and user-interface events and window-title-change events (e.g., obtained from an operating-system sensor). The Web-access requests and window-title-change events are shown in a single list of user-activity data in table 1500, though in certain embodiments they may be recorded separately (e.g., in separate lists or tables of user-activity data). The entries in the exemplary table 1500 are chronologically ordered and show the time of the event in column 1502, the type of event in 1504, and selected information concerning the event in 1506. For the exemplary data shown in table 1500, two types of user activities are shown in column 1504: (1) Web accesses; and (2) window-title changes. The corresponding information shown in column 1506 comprises: (1) the URL address for each Web access; and (2) the name of the new window title for each window-title change.

The first entry in the table 1500 corresponds to a window title change (and is indicative of a search being performed on the Google® search engine for the terms: “cnn,” “rice,” “commission,” and “testimony”). As each of the next few network-access requests is made, the network response thereto is monitored (process block 1402) and checked to determine whether it includes a title-change directive (e.g., “<title> . . . </title>”) (process block 1404). For purposes of this example, assume that the Internet response to entry 1510 has HTML with the following title directive: “<title>CNN.com—Rice delivers tough defense of administration—Apr. 8, 2004</title>.” Thus, when the Internet response to entry 1510 is received (process block 1402), a title-change directive is found (process block 1404), and any window-change events within a specified period of time (e.g., two seconds) are found (process block 1406). In this example, two window-change events occurred within the specified period of time: the change to

“http://www.cnn.com/2004/ALLPOLITICS/04/08/911.commission/” at entry 1512 and the change to “CNN.com—Rice delivers tough defense of administration—Apr. 8, 2004” at entry 1514. (In this case, the window title first changed to the URL address being accessed as part of the standard operation of the Web browser, not as a result of a title directive.) The two titles are evaluated to determine whether they match the title in the title directive (process block 1408). Consequently, the window title change at entry 1514 is matched to the title directive (“CNN.com—Rice delivers tough defense of administration—Apr. 8, 2004”) and is associated with the URL address from entry 1510, which prompted the title change directive.

In the exemplary implementation illustrated in FIG. 16, whenever the user works in a particular window, the window can be associated with a particular Web access. For instance, as shown in image 1600 in FIG. 16, the URL address 1612 and the window title 1610 can be output to the user whenever he or she points to the window with cursor 1620. More specifically, the operating-system sensor can be used to monitor the number of open windows at a user's workstation and the location of the window on the user's screen. The operating-system sensor can then be used to identify a particular window from the screen coordinates of the user's cursor (e.g., cursor 1620 in FIG. 16). The URL address associated with the window being selected can then be output to the user (e.g., as part of the window title, as in the image 1600 in FIG. 16).

The heuristic described above does not necessarily need to operate in the sequence shown above, as certain described operations may in some cases be rearranged or performed concurrently.

### Exemplary Computing Environments

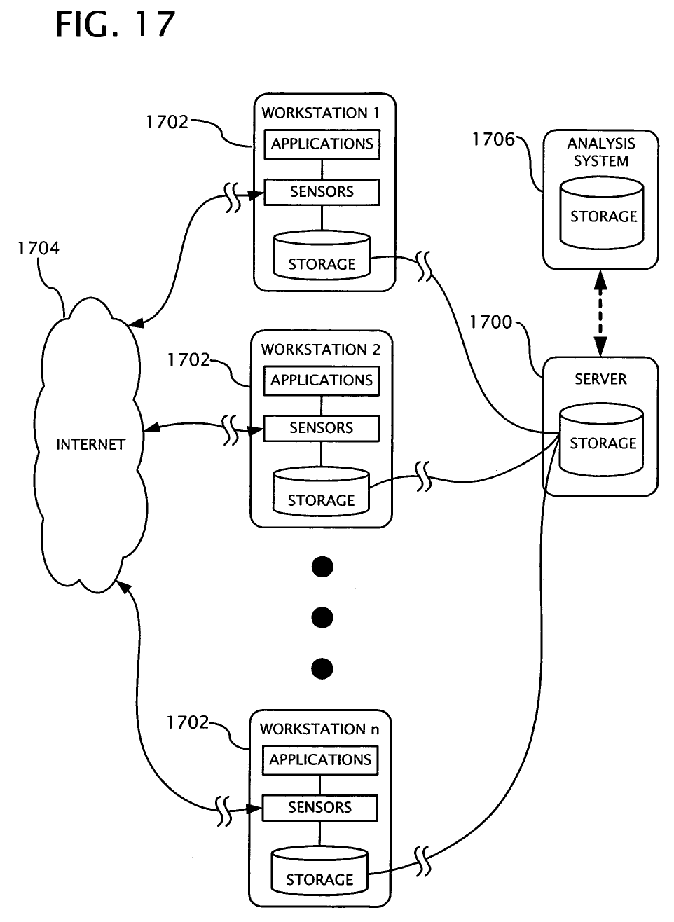

Any of the aspects of the technology described above may be performed on a single computer workstation or using a distributed computer network. An example of a distributed computer network according to one embodiment is shown in FIG. 17. In FIG. 17, a server 1700 has an associated storage device (internal or external to the server computer). The server 1700 is coupled to one or more user workstations 1702 through a network, which can comprise, for example, a wide-area network, a local-area network, a client-server network, the Internet, or other such network. The server 1700 may be used to support and control the monitoring software running on the workstations. In the illustrated network, the one or more user workstations 1702 are further coupled to the Internet 1704, but in other embodiments may be coupled to additional or alternative networks. The workstations 1702 may be configured to store their unprocessed or partially analyzed user-activity data internally for a period of time (e.g., one day), after which time the user-activity data is transferred to the server 1700. Alternatively, the server 1700 may store a workstation's user-activity data directly. In one embodiment, the server 1700 analyzes the user-activity data using any of the techniques described above. In another embodiment, and as illustrated in FIG. 17, a separate computer system 1706 is used to perform the analysis. The analysis system 1706 can be coupled to the server 1700 through a network (e.g., a wide-area network, a local-area network, a client-server network, the Internet, or other such network) across which the user-activity data and/or resulting lists of targeted user activities are transferred. Alternatively, the user-activity data may be stored on transportable computer-readable media (e.g., a hard drive or CD-ROM), which can be physically transferred to and analyzed by the analysis system 1706. Likewise, any resulting list created by the analysis system (e.g., a list of targeted user activities) can also be stored on one or more transportable computer-readable media.

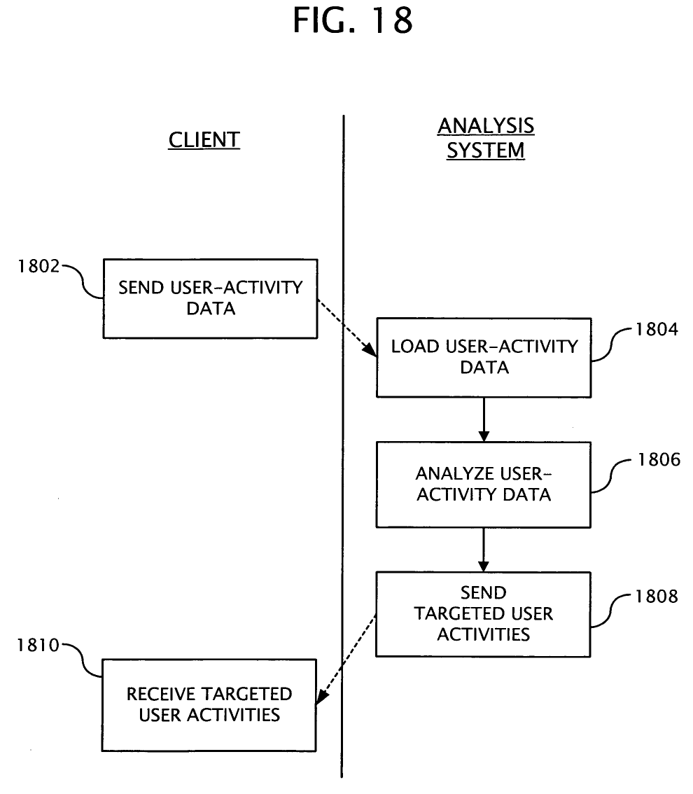

FIG. 18 shows that stored, user-activity data may be analyzed to create a list of targeted user activities according to any of the embodiments disclosed herein using a remote analysis system (such as the analysis system 1706 shown in FIG. 17). At process block 1802, for example, a client computer sends raw, user-activity data to an analysis system (e.g., a separate computer configured to perform any of the embodiments described above). At process block 1804, the user-activity data is received and loaded by the analysis system. At process block 1806, the user-activity data is analyzed and one or more lists comprising the targeted user activities are created using any of the disclosed embodiments. At process block 1808, the analysis system sends the lists of targeted user activities to the client computer, which receives the lists at process block 1810. It should be apparent to those skilled in the art that the example shown in FIG. 18 is not the only way to analyze the user-activity data. For example, the analysis system may perform only a portion of the analysis procedure.

Having illustrated and described the principles of the illustrated embodiments, it will be apparent to those skilled in the art that the embodiments can be modified in arrangement and detail without departing from such principles. Those skilled in the art will recognize that the disclosed embodiments can be easily modified to accommodate different situations and applications.

In view of the many possible embodiments, it will be recognized that the illustrated embodiments include only examples and should not be taken as a limitation on the scope of the disclosed technology. Rather, the disclosed technology comprises all novel and non-obvious features and aspects of the various disclosed embodiments and their equivalents, alone and in various combinations and sub-combinations with one another.

1. A method, comprising:
receiving user-activity data, the user-activity data comprising one or more network-access requests;
comparing a selected network-access request from the user-activity data to one or more known non-user-initiated network-access requests; and
designating the selected network-access request as being a user-initiated network-access request based at least in part on the comparison.

2. The method of claim 1, wherein the comparing comprises determining that the selected network-access request does not match any of the known non-user-initiated network-access requests.

3. The method of claim 1, wherein the user-activity data further comprises one or more user-interface events, the method further comprising determining that the selected network-access request is responsive to an immediately prior user-interface event.

4. The method of claim 3, wherein the one or more user-interface events correspond to keystrokes or mouse clicks performed at the workstation

5. The method of claim 1, further comprising outputting a list of targeted user activities, the list of targeted user activities comprising at least the designated user-initiated network-access request.

6. The method of claim 1, wherein the known non-user-initiated network-access requests are stored in one or more lists of known non-user-initiated network-access requests.

7. The method of claim 6, wherein the one or more lists of known non-user-initiated network-access requests comprise a list of URL addresses known to be secondary URL addresses.

8. The method of claim 6, wherein the one or more lists of known non-user-initiated network-access requests comprise a list of URL addresses known to be of a non-primary type.

9. The method of claim 6, wherein the selected network-access request is a first network-access request, the method further comprising:
identifying a second selected network-access request as being a non-user-initiated network-access request from the user-activity data; and
updating one of the lists of known non-user-initiated network-access requests to include the non-user-initiated network-access request identified.

10. The method of claim 9, wherein the user-activity data further comprises one or more user-interface events, the method further comprising determining that the second selected network-access request does not immediately follow a user-interface event.

11. The method of claim 1, wherein the network-access requests correspond to uniform-resource-locator (URL) addresses accessed by the computer workstation.

12. One or more computer-readable media comprising computer-executable instructions for causing a computer to perform the method of claim 1.

13. One or more computer-readable media comprising a list of user-initiated network-access requests created at least partially by the method of claim 1.

14. A method, comprising:
receiving data indicating activity at a computer workstation, wherein the data comprises entries indicative of network-access requests from the computer workstation, wherein the network-access requests comprise both user-initiated network-access requests and non-user-initiated network-access requests; and
via the data indicating activity at the computer workstation, designating one or more of the network-access requests as user-initiated network-access requests.

15. The method of claim 14, wherein the data further comprises entries indicative of user-interface events, the method further comprising identifying at least one of the user-interface events as a user-interface event initiating at least one of the network-access requests.

16. The method of claim 14; wherein the act of designating one or more of the network-access requests as user-initiated network-access requests comprises searching one or more lists of non-user-initiated network-access requests.

17. The method of claim 14, further comprising, via the data indicating activity at the computer workstation, identifying one or more of the network-access requests as non-user-initiated network-access requests.

18. The method of claim 17, further comprising updating a list of non-user-initiated network-access requests with one or more of the network-access requests identified as non-user-initiated network-access requests.

19. The method of claim 14, further comprising, via the data indicating activity at the computer workstation, identifying one or more search queries from the network-access requests.

20. One or more computer-readable media comprising computer-executable instructions for causing a computer to perform the method of claim 14.

21. One or more computer-readable media comprising a list of user-initiated network-access requests created at least partially by the method of claim 14.

22. A method, comprising:
receiving user-activity data, the user-activity data comprising one or more network-access requests;
comparing a selected network-access request from the user-activity data to known search-engine-query addresses;
identifying the selected network-access request as being a search-engine query by matching the selected network-access request to one of the known search-engine-query addresses; and
identifying a user query to the search engine from the selected network-access request.

23. The method of claim 22, further comprising outputting a list of targeted user activities, the list of targeted user activities comprising at least the search-engine query identified.

24. The method of claim 22, wherein the user-interface events correspond to keystrokes or mouse clicks performed at the workstation.

25. The method of claim 22, wherein the network-access requests correspond to uniform resource locator (URL) addresses accessed by the workstation.

26. The method of claim 22, wherein the known search-engine-query addresses comprise URL addresses for known Internet search engines.

27. One or more computer-readable media comprising computer-executable instructions for causing a computer to perform the method of claim 22.

28. One or more computer-readable media comprising a list of search-engine queries created at least partially by the method of claim 22.

29. A method, comprising:
receiving user-activity data, the user-activity data comprising one or more file-activity events, each file-activity event being indicative of a respective file that was accessed by a computer workstation and a process that accessed the respective file on the computer workstation;
clustering two or more of the file-activity events together, the two or more file-activity events involving a common file accessed by a common process, the two or more file-activity events occurring within respective time intervals from one another; and
classifying the clustered file-activity events as being representative of a targeted file action.

30. The method of claim 29, wherein the classifying comprises:
comparing a time associated with the clustered file-activity events to a creation time of the common file; and
designating the clustered file-activity events as representing a creation of the common file based at least in part on the comparison.

31. The method of claim 30, wherein the comparing and the designating are performed for the clustered file-activity events only after the clustering is determined to be complete for the clustered file-activity events.

32. The method of claim 29, wherein the classifying comprises:
comparing a time associated with the clustered file-activity events to a modification time of the common file; and
designating the cluster file-activity events as representing either a modification of the common file or an opening of the common file based at least in part on the comparison.

33. The method of claim 29, wherein the classifying comprises:
comparing a time associated with the clustered file-activity events to a creation time and a modification time of the common file; and
designating the clustered file-activity events as representing a creation, a modification, or an opening of the common file based at least in part on the comparison.

34. The method of claim 29, further comprising deleting a selected file-activity event from the user-activity data if the selected file-activity event indicates access to a file on a list of excluded files.

35. The method of claim 34, wherein the list of excluded files comprises temporary files.

36. The method of claim 29, further comprising outputting a list of targeted user activities, the list of targeted user activities comprising at least the targeted file action represented by the clustered file-activity events.

37. The method of claim 29, wherein the clustering and classifying are performed substantially as the user-activity data is received.

38. One or more computer-readable media comprising computer-executable instructions for causing a computer to perform the method of claim 29.

39. One or more computer-readable media comprising a list of targeted file actions created at least partially by the method of claim 29.

40. A method, comprising:
monitoring network-access requests from a computer workstation and network responses to the network-access requests;
identifying a network response that directs the computer workstation to perform a window title change, the identified network response being received in response to a corresponding network-access request;
determining that a window on the computer workstation changed as a result of the identified network response; and
associating the window with the corresponding network-access request.

41. The method of claim 40, wherein the determining comprises evaluating whether the window on the computer workstation changed titles within a predetermined period of time of the identified network response and whether a new title of the window matches a title directed by the identified network response.

42. The method of claim 40, further comprising associating user commentary concerning the window with the corresponding network-access request.

43. The method of claim 40, wherein the corresponding network-access request comprises a URL address.

44. The method of claim 40, wherein the identified network response comprises an HTML directive to change window titles.

45. The method of claim 40, wherein the identifying, determining, and associating are performed substantially concurrent with the monitoring.

46. One or more computer-readable media comprising computer-executable instructions for causing a computer to perform the method of claim 40.

47. A method for analyzing user-activity data, comprising:
detecting two or more data streams of low-level, user-activity data at a computer workstation via two or more respective sensors, the two or more respective sensors comprising at least a first sensor configured to detect network-access requests and a second sensor configured to detect at least one of file-activity events, window-title-change events, or user-interface events at the computer workstation;
identifying targeted user activity from at least one of the data streams; storing
the targeted user activity; and
disregarding a remainder of the at least one of the data streams from which the targeted user activity is identified.

48. The method of claim 47, wherein the targeted user activity is identified using a combination of at least two of the data streams.

49. The method of claim 47, wherein the second sensor is configured to detect at least the user-interface events, and wherein the targeted user activity indicates a user initiating a network access.

50. The method of claim 49, wherein the targeted user activity further indicates a user query made to a network search engine during the network access initiated by the user.

51. The method of claim 47, wherein the second sensor is configured to detect at least the file-activity events, and wherein the targeted user activity indicates a user creating, opening, or modifying a file.

52. The method of claim 47, wherein the second sensor is configured to detect at least the window-title-change events, and wherein the targeted user activity indicates a user initiating a network access that changes a window title on the user's computer workstation.

53. The method of claim 47, wherein the identifying the targeted user activity is performed substantially as a corresponding data stream is received.

54. The method of claim 47, wherein the targeted user activity is displayed via a graphical user interface.

55. One or more computer-readable media comprising computer-executable instructions for causing a computer to perform the method of claim 47.

56. One or more computer-readable media comprising a list of targeted file activity created by the method of claim 47.
